(19) United States
(12) Patent Application Publication
(10) Pub. No.: US 2026/0004147 A1
(43) Pub. Date: Jan. 1, 2026

(54) Method and System for edge intelligence using federated learning with blockchain, covariance matrix transfer, and artificial intelligence (FLwBC-AI)

(71) Applicant: Veea Inc., New York, NY (US)

(72) Inventors: Clint SMITH, New York, NY (US); Allen SALMASI, New York, NY (US)

(21) Appl. No.: 19/249,946

(22) Filed: Jun. 25, 2025

Related U.S. Application Data
(60) Provisional application No. 63/664,273, filed on Jun. 26, 2024.

(51) Int. Cl. G06N 3/098

(52) U.S. Cl. CPC G06N 3/098

(57) ABSTRACT

This disclosure describes methods for distributed machine learning across edge nodes. An edge node acquires new data and checks with a federated server for an updated large language model (LLM) or small learning model (SLM). If available, it downloads the update; otherwise, it uses the existing model. The edge node then trains the LLM/SLM on its new data and sends the updated model back to the server. This enables continuous, privacy-preserving model improvement with low communication overhead. Additionally, methods are provided for sequential task execution at the edge: a smart contract provides a pointer to a covariance matrix, which is loaded into a neural network. The edge node processes sensor data to generate a task output, then repeats the process for subsequent tasks using new matrices and updated models as needed.

### RELATED APPLICATIONS

This application claims the benefit of priority to U.S. Provisional Patent Application No. 63/664,273 entitled “Method and System for edge intelligence using federated learning with blockchain and artificial intelligence (FLwBC-AI)” filed on Jun. 26, 2024, the entire contents of which are hereby incorporated by reference for all purposes.

### BACKGROUND

Artificial Intelligence (AI) integrated with edge computing offers significant advancements in dynamic and heterogeneous edge environments. Edge computing allows data processing near the source, reducing latency and enhancing real-time applications. Federated Learning (FL), a machine learning technique, trains models across decentralized nodes, ensuring data privacy and reducing communication overhead. Blockchain technology, with its immutable security and traceability, further enhances federated learning by providing decentralized control and secure data handling. Combining these technologies creates a new paradigm in edge computing, enabling efficient and secure distributed AI applications. The FLwBC-AI system may provide a robust solution for implementing AI at the edge, addressing privacy, communication, and heterogeneity challenges while ensuring secure and efficient model management through blockchain technology. This integration may enhance the capabilities and performance of edge computing applications, making them more adaptable and resilient to dynamic environments.

### SUMMARY

Various aspects include methods of edge intelligence using federated learning with blockchain and artificial intelligence (FLwBC-AI), which may include deploying a plurality of edge computing nodes (ECNs) each with local data storage and processing capabilities, initializing a federated learning (FL) framework on each of the ECNs, setting up a blockchain infrastructure for secure and immutable data logging, deploying artificial intelligence and machine learning models (LLM/SLM) on the ECNs and controller nodes, collecting data locally on each of the ECNs from connected edge devices, preprocessing the collected data locally on each of the ECNs, initializing local model parameters on each of the ECNs, training the local model using the preprocessed data on each of the ECNs, performing periodic training rounds to update the local model parameters on each of the ECNs, encrypting and sending local model updates from each of the ECNs to a central blockchain ledger, using smart contracts to validate and log the model updates on the blockchain, aggregating the model updates from all the ECNs to update a global model using a predetermined aggregation algorithm, storing the updated global model on the blockchain or an interplanetary file system (IPFS), using smart contracts to notify the ECNs about the availability of the updated global model, fetching and updating the local models on each of the ECNs with the latest global model parameters, and repeating the operations of collecting data, preprocessing data, training local models, encrypting, sending, and updating models to implement continuous learning and adaptation.

Some aspects may further include deploying Kalman Filter (KF) algorithms on edge computing nodes (ECNs) and a central controller node, initializing KF parameters, which may include state vectors and covariance matrices for model weight updates, training the local models on each of the ECNs using the current dataset and the KF algorithm, using the KF to estimate and update model weights based on the training data, incorporating confidence values to adjust the influence of different data points on the model training, encrypting and sending the KF-adjusted model updates from each of the ECNs to the central controller node, validating and logging the KF-adjusted model updates using the blockchain infrastructure, aggregating the KF-adjusted model updates at the central controller node, refining the global model using the KF-based predictive inference logic (PHIL), distributing the updated global model to all the ECNs, using the new global model for inference and continuous training on each of the ECNs, collecting and using feedback on model performance to further adjust KF parameters for subsequent training.

Some aspects may further include deploying smart contracts on the blockchain to manage the model updates and distribution, defining rules and conditions within the smart contracts for model updates, validation, and distribution, encrypting and sending model updates from each of the ECNs to the blockchain, using the smart contracts to validate and log the model updates on the blockchain, aggregating the validated model updates using a predefined aggregation algorithm, storing the aggregated models on the blockchain or IPFS, updating the smart contracts with new model information and locations, reading the smart contracts on each of the ECNs to determine the location of the latest model updates, fetching and deploying the updated models on each of the ECNs as specified by the smart contracts, using the deployed models for local inference and continuous training on each of the ECNs, maintaining version control of the models using the blockchain infrastructure, using the smart contracts to specify conditions for model version updates and rollbacks, and enhancing the model usage based on application-specific requirements which may include latency and resource constraints.

Some aspects may further include using a containerized environment on the ECNs for running AI/ML components, separating the training container from the model container in the containerized environment, running multiple LLM/SLM models in parallel within the containerized environment on the ECNs, using unique or shared data sets for each LLM/SLM model within the containerized environment, providing inference outputs from the LLM/SLM models to applications running on the ECNs, using the inference outputs to perform actions, which may include turning devices on or off, issuing text questions, or activating devices, aggregating the outputs from multiple LLM/SLM models to a single application or multiple applications on the ECNs, and using the aggregated outputs for further processing and decision-making within the applications.

Some aspects may further include creating a wireless distribution system using FLwBC-AI for automatic topology learning and configuration, adapting the network to changing needs through continuous learning and adjustment, ensuring continuous availability and resilience of the network, protecting the network and its users through secure and immutable logging of model updates and configurations, planning for future scalability and adaptability of the network, using LLM/SLM models to achieve network optimization, which may include connectivity, resource allocation, application/service delivery, security, and initial/default services, and using the smart contracts on the blockchain to define optimization goals and specify the LLM/SLM models needed for achieving these goals.

Some aspects may further include methods for enabling distributed machine learning across edge computing nodes, comprising obtaining new data at an edge node, checking a federated server for a new or updated large language model (LLM) or smaller learning model (SLM), obtaining the new or updated LLM/SLM if available or utilizing a current LLM/SLM, training the LLM/SLM using the new data set, and sending an updated LLM/SLM to the federated server upon completion of training. The method may further include receiving the updated LLM/SLM at the federated server from multiple edge nodes, aggregating the received model updates to create an improved global model, and making the improved global model available for distribution to edge nodes.

Some aspects may further include methods for implementing adaptive machine learning in a distributed edge computing environment, comprising selecting an LLM/SLM matching an AI function, obtaining a data set containing values, obtaining confidence values for the data set, obtaining covariance matrix confidence values, assigning weights using a Kalman Filter Algorithm incorporating current and previous confidence values, applying weights to data set values based on confidence values, summing the weighted data set values, and updating covariance matrix confidence values if the summation does not match a desired output.

In some aspects, a method for sequential execution of multiple tasks on an edge computing node involves receiving a first pointer from a smart contract that locates a first covariance matrix, loading that first covariance matrix into a neural network stored on the edge computing node, and processing sensor data with the neural network to obtain a first task output. The method continues by receiving a second pointer from the smart contract that locates a second covariance matrix, loading the second covariance matrix into the neural network, and processing the sensor data with the neural network to obtain a second task output. The method may optionally include receiving a third pointer from the smart contract that locates a third covariance matrix, loading the third covariance matrix into the neural network, and processing the first task output and the second task output with the neural network to obtain a combined output.

In some aspects, each pointer may reside in a field named matrix_pointer within the smart contract. In some aspects, the smart contract may reside on a blockchain that uses an interplanetary file system for matrix storage. In some cases, the logic may measure available memory and decide whether to load the third covariance matrix. In some aspects, the method may further include monitoring performance metrics of the neural network during task execution, generating updated covariance matrix values based on the performance metrics, storing the updated covariance matrix values on the blockchain or IPFS, and updating the smart contract with new pointers to the updated covariance matrix values.

Some aspects may further include methods for implementing blockchain-based federated learning in a distributed edge computing environment, comprising obtaining data for training an LLM/SLM at an edge node, commencing training using a neural network training container, completing training using a local data set, storing a newly trained LLM/SLM including covariance matrix values for each layer, querying edge nodes for LLM/SLM covariance matrix value updates at a control node, sending new LLM/SLM covariance matrix values from edge nodes to the control node, commencing training of the LLM/SLM at the control node, completing training using edge node training data, updating the LLM/SLM model with covariance matrix values and storing it on a blockchain or IPFS, updating a smart contract indicating the location of the updated LLM/SLM model, querying the smart contract by edge nodes to determine availability of a new LLM/SLM, obtaining the location of the new LLM/SLM from the smart contract, and obtaining the new LLM/SLM from the blockchain or IPFS.

Further aspects may include a computing device having a processor configured with processor-executable instructions to perform various operations corresponding to the methods discussed above. Further aspects may include a computing device having various means for performing functions corresponding to the method operations discussed above. Further aspects may include a non-transitory processor-readable storage medium having stored thereon processor-executable instructions configured to cause a processor to perform various operations corresponding to the method operations discussed above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1 illustrates a block diagram of a FedAvg and FedMD architecture for edge computing nodes, according to aspects of the present disclosure.

FIG. 2 illustrates a flowchart of a method for updating and managing model data in an edge computing environment, according to an embodiment.

FIG. 3A illustrates a flowchart of a method for processing data at an edge node, according to aspects of the present disclosure.

FIG. 3B illustrates a continuation of the flowchart of FIG. 3A, according to aspects of the present disclosure.

FIG. 4 illustrates a block diagram of a system including a Kalman filter algorithm architecture, according to an embodiment.

FIG. 5 illustrates a flowchart of a Predictive Holistic Inference Logic (PHIL) method, according to aspects of the present disclosure.

FIG. 6 illustrates a block diagram of a three-node network implementing federated learning with blockchain and artificial intelligence, according to an embodiment.

FIG. 7 illustrates a flowchart showing a process for training and updating an LLM/SLM model, according to aspects of the present disclosure.

FIG. 8 illustrates a flowchart showing a method for training and updating an LLM/SLM application, according to an embodiment.

FIG. 9 illustrates a block diagram of an alternative three-node network, according to aspects of the present disclosure.

FIG. 10 illustrates a flowchart of a method for updating and managing model data in an edge computing environment, according to an embodiment.

FIG. 11 illustrates a network system showing a distributed computing architecture, according to aspects of the present disclosure.

FIG. 12 illustrates a block diagram of a system architecture for edge computing with blockchain integration, according to an embodiment.

FIG. 13 illustrates a block diagram of an edge computing node architecture, according to aspects of the present disclosure.

FIG. 14 illustrates a block diagram of an alternative edge computing node architecture, according to an embodiment.

FIG. 15 illustrates a system architecture showing a hierarchical block structure with interconnected components, according to aspects of the present disclosure.

FIG. 16 illustrates a smart contract system showing a hierarchical arrangement of blocks, according to an embodiment.

FIG. 17 illustrates a flowchart of a method for edge nodes to query and obtain instructions from a smart contract, according to aspects of the present disclosure.

FIG. 18 illustrates a block diagram of an edge compute optimization system, according to an embodiment.

FIG. 19 illustrates a block diagram of an edge compute node provisioning process, according to aspects of the present disclosure.

FIG. 20 illustrates a block diagram of a federated learning system, according to an embodiment.

FIG. 21 illustrates an orthogonal view of a server device, according to aspects of the present disclosure.

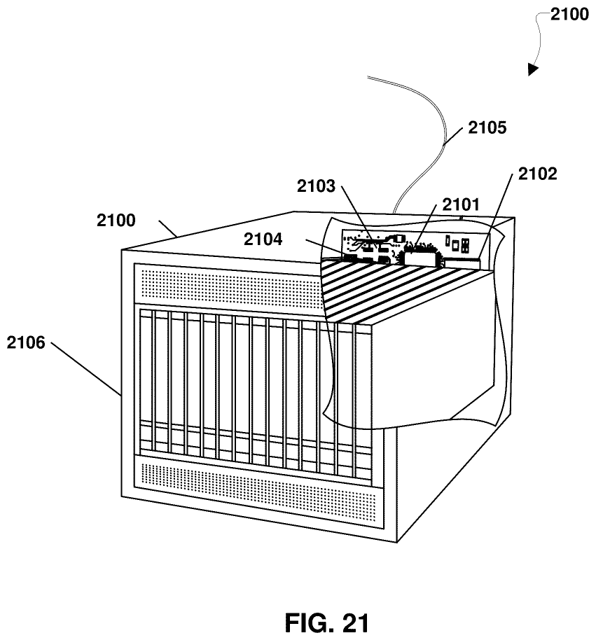

### DETAILED DESCRIPTION

Various embodiments will be described in detail with reference to the accompanying drawings. Whenever possible, the same reference numbers will be used throughout the drawings to refer to the same or similar parts. References made to particular examples and implementations are for illustrative purposes and are not intended to limit the scope of the claims.

Generally, implementing AI at the edge involves several challenges, including data privacy, communication costs, system heterogeneity, and unreliable model updates. Traditional centralized AI training methods may compromise data privacy and require significant communication overhead. Edge environments are dynamic, with heterogeneous devices having varying data amounts, computing capacities, and communication capabilities. This heterogeneity may complicate model training and data processing, leading to models with reduced accuracy and generalization. In addition, maintaining synchronized and efficient model updates across distributed nodes may present further challenges in achieving adequate AI performance at the edge.

The various embodiments include methods and computing devices configured to implement the methods (referred to as Federated Learning with Blockchain and Artificial Intelligence (FLwBC-AI) system) to address and overcome these and other technical challenges by integrating AI, FL, and blockchain technologies. The embodiments may allow for decentralized model training across edge nodes, ensuring data privacy and reducing communication overhead. The use of blockchain may ensure secure and immutable model updates, enhancing the reliability and traceability of the learning process.

The FLwBC-AI system may provide a robust solution for implementing AI at the edge, addressing privacy, communication, and heterogeneity challenges while ensuring secure and efficient model management through blockchain technology. This integration may enhance the capabilities and performance of edge computing applications, making them more adaptable and resilient to dynamic environments.

For example, in some embodiments, the FLwBC-AI system may be configured to enable decentralized training of AI models across multiple edge nodes without transferring raw data. Each node may train the model locally and share updates with a central server, which aggregates these updates to create a global model. This approach may ensure data privacy and reduce communication overhead.

In some embodiments, the FLwBC-AI system may be configured to use blockchain technology to provide a decentralized and secure architecture for FL systems. This may ensure immutable and traceable model updates, enhancing the security and reliability of the training process. Smart contracts on the blockchain may manage the distribution and updating of model parameters so that only validated updates are incorporated into the global model.

In some embodiments, the FLwBC-AI system may be configured to support continuous learning and adjustment of weights and biases for AI models, particularly neural networks. Kalman filters in the training process may help set and adjust these weights and biases, improving the accuracy and convergence speed of the models.

In some embodiments, the FLwBC-AI system may be configured to address the heterogeneity of edge devices by using smaller learning models (SLMs) tailored for specific tasks. These SLMs may be pruned versions of larger models (LLMs) optimized for the capabilities of individual edge nodes. This approach may ensure efficient model training and application delivery in a heterogeneous environment.

In some embodiments, the FLwBC-AI system may be configured to improve edge intelligence by considering multiple criteria, including device capability, latency, privacy, energy efficiency, resource cost, and bandwidth cost. This optimization may be application-dependent to ensure the best performance for specific edge applications.

In some embodiments, the FLwBC-AI system may be configured to run AI/ML components in containerized environments, allowing for flexible and scalable deployment. Each edge node may host multiple containers, each running different models or services. This microservices architecture may enhance the system's ability to adapt to changing requirements and efficiently manage resources.

In some embodiments, the FLwBC-AI system may be configured to use smart contracts on the blockchain to manage the distribution, updating, and retrieval of AI models. These contracts may define the location and versioning of models so that edge nodes always use the most relevant and up-to-date models for their tasks. Smart contracts may also allow for resource reuse and model swapping based on application needs.

These and other operations performed by the various embodiments may improve the performance and functioning of a computing system. Additional improvements to the performance and functioning of the computing system will be evident from the disclosures below.

The term “neural network” may be used herein to refer to an interconnected group of processing nodes that collectively operate as a software application to control a computing device's function or generate an inference result. Individual nodes may receive input data, perform simple operations to generate output data (activation) and pass it to the next node. Each node may have a weight value defining the relationship between input and output data. Neural networks may learn new tasks by adjusting these weights during training, in which the network may process tasks with known outputs, compare activations to expected outputs, and adjust weights based on these comparisons. After training, the neural network may perform inference to process new tasks using the determined weights.

The term “inference” may be used herein to refer to the runtime process of traversing neural network nodes to produce values as an overall activation or inference result.

Deep neural networks may have a layered architecture in which each layer's activation serves as the next layer's input. This structure may distribute computations over a network of processing nodes. Deep neural networks may include activation functions between layers, such as rectified linear units. Layers may include input, output, and intermediate (hidden) layers.

Each layer in a neural network may have multiple inputs and preceding layers. For simplicity, embodiments may reference a single input or preceding layer, but it should be understood that the operations may apply to multiple inputs and layers.

The term “recurrent neural network” (RNN) may be used herein to refer to neural networks suited for sequence data processing, including cycles or loops allowing information to persist. RNNs may maintain a memory of previous inputs, which may be beneficial for tasks involving temporal dynamics and context.

The term “convolutional neural network” (CNN) may be used herein to refer to a deep neural network in which computation in at least one layer is structured as a convolution. CNNs may use a hierarchy of convolution-based layers and apply the same weight matrices (filters) to every output, implementing a fixed feedforward structure for sequential operations on layer outputs and generating overall inference results.

The term “network configuration” may be used herein to refer to setting up network devices and software to manage data flow and communications, including setting parameters such as routing protocols, node roles, bandwidth allocation, and security policies to meet user and service demands. Network configuration may apply to physical devices (routers, switches, access points) and software components (firewall settings, QoS parameters).

Various embodiments may use a variety of current and future wired and wireless communication networks, technologies, and standards, including Bluetooth®, ZigBee, LoRa, WiFi6, LTE, 5G, 6G, GSM, UMTS, HSDPA, CDMA, and others. These technologies may involve transmitting and receiving data, signaling, and content messages. References to specific technologies are illustrative and not intended to limit the claims unless specifically recited.

The term “artificial intelligence” (AI) may be used herein to refer to models, techniques, or technologies for the simulation of human intelligence processes by computer systems. These processes may include learning (e.g., the acquisition of information and rules for using the information, etc.), reasoning (e.g., using rules to reach approximate or definite conclusions, etc.), and self-correction. AI may encompass a variety of techniques, such as machine learning, deep learning, natural language processing, and neural networks, which may allow machines to perform tasks that typically require human intelligence, such as visual perception, speech recognition, decision-making, and language translation.

The term “federated learning” (FL) may be used herein to refer to a decentralized machine learning approach in which multiple devices or servers collaboratively train a model while keeping the training data localized. Federated learning may allow for the training of models on data distributed across multiple locations without the need to centralize the data. This approach may enhance data privacy and security, as data remains on the local devices, and only model updates (e.g., gradients or model weights) are shared and aggregated. Federated learning may be particularly useful in scenarios in which data privacy is a concern or in which data is too large or sensitive to be moved.

The term “blockchain” may be used herein to refer to a distributed ledger technology that records transactions across many computers in such a way that the registered transactions cannot be altered retroactively. blockchain may allow for transparency, security, and decentralization by storing data in blocks that are linked together in a chain. Each block may contain a cryptographic hash of the previous block, a timestamp, and transaction data. The decentralized nature of blockchain may provide immutable, secure, and traceable records, making it suitable for applications that benefit from high levels of data integrity and trust, such as financial transactions, supply chain management, and federated learning systems.

The term “computing device” may be used herein to refer to quantum computing devices, edge devices, Internet access gateways, modems, routers, network switches, personal computers, laptops, tablets, smartphones, wearables, IoT devices, media players, gaming systems, and similar devices with a programmable processor and communications circuitry.

The term “mobile device” may be used herein to refer to wireless devices, IoT devices, smartphones, multimedia players, PDAs, laptops, tablets, smart cars, connected vehicles, and wearables with a programmable processor, memory, and wireless communication circuitry. These embodiments may be useful in any electronic device with a programmable processor for extended reality applications.

The terms “component,” “system,” and the like may be used herein to refer to computer-related entities, such as hardware, firmware, software, or software during execution, configured to perform specific operations. A component may encompass a process, processor, object, executable, thread, program, or computing device. Components may be localized or distributed across multiple processors or cores and execute from various non-transitory computer-readable media.

The term “system on chip” (SOC) may be used herein to refer to an integrated circuit containing multiple resources and processors on a single substrate, including digital, analog, mixed-signal, and RF functions. SOCs may include software for controlling integrated resources and peripherals.

The term “system in a package” (SIP) may be used herein to refer to a module containing multiple resources, computational units, and processors on two or more IC chips or substrates. SIPs may facilitate high-speed communication and resource sharing.

The term “multicore processor” may be used herein to refer to an IC chip containing two or more independent processing cores configured to read and execute program instructions. A SOC may include multiple multicore processors.

The term “container” may be used herein to refer to a software component supporting virtualization technology, allowing for resource abstraction and separating applications from their underlying infrastructure. Containers may operate as isolated user-space instances with resource management features to limit impact on other containers.

The term “computing mesh” may be used herein to refer to techniques for distributing or linking computing resources connected by communication links, forming a self-organizing network for resource sharing. The term “application mesh” may be used herein to refer to techniques for running applications across different devices connected by communication links, utilizing resources from multiple nodes for application functions. The term “connectivity mesh” may be used herein to refer to techniques for connecting computing platforms to share resources, run applications, and provide connectivity, often in a self-organizing network.

The term “edge computing” may be used herein to refer to systems that improve user experience by offloading computation-intensive tasks to edge devices or servers, freeing up resources on the computing device. The term “edge device” may be used herein to refer to a computing device with a programmable processor and communications circuitry for establishing links to consumer devices and network components. Edge devices may perform edge computing techniques. An edge computing system may combine remote cloud servers and edge devices to improve performance, latency, and energy consumption. Edge devices may offer lower latency but have limited resources compared to cloud servers. An edge computing system may balance these trade-offs for optimized performance and latency. In some embodiments, the edge computing system may balance performance, latency, power consumption, and other trade-offs by using a computing mesh, application mesh, or connectivity mesh. For example, the edge computing system may include several edge devices connected by wireless or wired communication links, configured to operate as a computing mesh in which each edge device's computing resources are shared. When several edge devices in a computing mesh are simultaneously served by the same cloud server, the edge computing system may intelligently and dynamically allocate available cloud computational resources to each edge device based on their workload, local computation capacities, and performance requirements.

In practical implementations, edge devices seldom host multiple complete neural networks simultaneously due to inherent memory constraints. Instead, a single neural network may sequentially perform multiple tasks if the device dynamically loads a task-specific covariance matrix before each pass. This sequential loading strategy conserves memory at the cost of increased latency, facilitating the efficient reuse of a shared neural network parameter space.

The term “processing system” may be used herein to refer to one or more processors, including multi-core processors, organized to perform various computing functions. Methods may be implemented in one or more processors within a processing system, which may be part of a computing device or a system-on-chip (SoC).

Some embodiments include a processing system configured to introduce artificial intelligence (AI) at the edge of the network. The processing system may perform operations that resolve configuration and application delivery in a dynamic ecosystem, referred to as elastic edge computing. The processing system may manage heterogeneous edge computing nodes (ECNs) and edge devices. Key operations of the processing system include adding and removing ECNs, managing backhaul changes, optimizing upstream network resource usage, allocating resources among ECNs, and managing resource allocation for edge devices.

The processing system may integrate AI with edge computing nodes at the network's edge, offering capabilities for resolving configuration and application delivery within dynamic ecosystems involving heterogeneous ECNs and edge devices. The system's operations may include the addition and removal of ECNs, adapting to backhaul changes, optimizing upstream network resource use, and managing resource allocation both among ECNs and for individual edge devices.

The processing system may enable edge intelligence by converging AI, federated learning (FL), and blockchain. This new paradigm in edge computing builds a cross-enterprise, cross-data, and cross-domain ecosystem for big data and AI systems using distributed and heterogeneous edge servers. These servers may handle varying amounts of data and diverse computing and storage capacities. The system leverages blockchain architecture for decentralized FL systems, using blockchain features such as immutability, security, and traceability.

The processing system may implement FL by training machine learning models over data collected on numerous nodes by one or multiple data owners. The processing system may use blockchain to reduce communication overhead by maintaining an optimal number of active parameters for node communication and AI model training.

The processing system may configure neural networks to use weights and biases for decision-making based on specific inputs. During training, the system may adjust these weights and biases and incorporate continuous learning to include new data and problems without discarding previous training.

The processing system may ensure data privacy by keeping data at the edge or on a wide-area private network, addressing concerns related to privacy protection, communication costs, system heterogeneity, and unreliable model uploads in FL. By integrating blockchain, the system may enhance FL's privacy, security, and performance, improving the operations and capabilities of edge applications.

The processing system may use FL to train AI models on contained devices, such as ECNs or edge devices, for local training to improve a global model incorporated into the blockchain. Combining AI/ML with blockchain and FL technologies, the system achieves greater decentralization and privacy. The system eliminates the need for a centralized server to collect data and perform model training, enhancing edge network performance and application delivery.

The processing system may set edge intelligence by considering multiple criteria, including device capability, latency, privacy, energy efficiency, resource cost, and bandwidth cost. The system may process data near its source to improve real-time processing and reduce latency, especially for AI systems like generative AI and language models that rely on extensive datasets for training.

The processing system may support distributed computing, which underpins both edge computing and FL, each with distinct attributes. The system may process local data for real-time applications in edge computing and decentralize model training in FL, sending model updates while keeping data local. The system facilitates on-device learning, maintaining privacy, and reducing communication payloads, which is significant with the growth of IoT devices.

The processing system may address the heterogeneity of edge devices and ECNs, which presents complications in data processing and model training. The system may handle devices with varying communication capabilities, data distributions, and available data samples, overcoming challenges in real-world FL applications where some devices rely on externally trained models.

The processing system may implement and use methods to address heterogeneity, such as using devices with similar capabilities within the ecosystem or utilizing smaller learning models (SLMs) specific to the application. The system may follow a server-client model in which client devices train models and communicate with a central server to share training knowledge. The system aims to increase convergence speed and achieve high accuracy despite constraints on devices.

Various embodiments disclosed herein present significant technological improvements in edge computing environments by integrating federated learning, blockchain, and Kalman filter algorithms. Specifically, the present system substantially enhances computational efficiency and reduces network communication overhead by allowing edge computing nodes (ECNs) to train models locally. By employing federated learning integrated with blockchain technology, this invention ensures secure, decentralized management of machine learning models, thus resolving persistent issues related to data privacy, network latency, and data integrity inherent in conventional centralized learning frameworks. Furthermore, the integration of the Kalman filter algorithm uniquely improves the accuracy and convergence speed of local and global model updates by dynamically adjusting model weights and biases based on statistical confidence measures.

A distinct technical feature of the present disclosure involves the utilization of blockchain infrastructure for secure, decentralized storage and validation of federated learning model parameters. Through smart contracts deployed within this blockchain environment, model updates from each ECN are securely validated, logged, and aggregated, creating a robust, immutable record of each training event and model evolution. The Kalman filter algorithm further contributes to these technical advantages by providing sophisticated predictive capabilities and adjusting model parameters in real-time based on evolving confidence values derived from local datasets. This unique combination of blockchain and Kalman filtering distinctly improves the system's resilience, adaptability, and reliability compared to existing federated learning frameworks.

Practical applications of the disclosed embodiments extend across numerous fields, showcasing significant benefits in real-world scenarios. For instance, in smart city environments, the present system enables rapid, secure, and privacy-preserving predictive analysis for traffic management, environmental monitoring, and emergency response, significantly enhancing urban safety and efficiency. In industrial IoT deployments, predictive maintenance and quality control systems leverage the described federated learning and blockchain integration to swiftly identify and respond to equipment anomalies with increased accuracy and minimal downtime. Healthcare monitoring systems utilize the disclosed invention to aggregate patient data securely from distributed sources, facilitating precise, timely diagnostics and personalized patient care without compromising patient privacy.

Addressing known technical challenges, the embodiments herein explicitly mitigate issues of network latency, bandwidth constraints, and data security vulnerabilities prevalent in traditional AI deployment models. By ensuring local training and minimal data movement, the system substantially reduces the communication payload between edge nodes and centralized servers, thereby addressing bandwidth limitations. Additionally, the decentralized blockchain model prevents single points of failure and secures model parameters against unauthorized access and manipulation, resolving significant security vulnerabilities identified in prior solutions. Finally, by deploying Kalman filters within the training process, the present invention directly addresses accuracy and convergence challenges typically encountered in heterogeneous and dynamic data environments, thereby significantly enhancing overall system robustness and reliability.

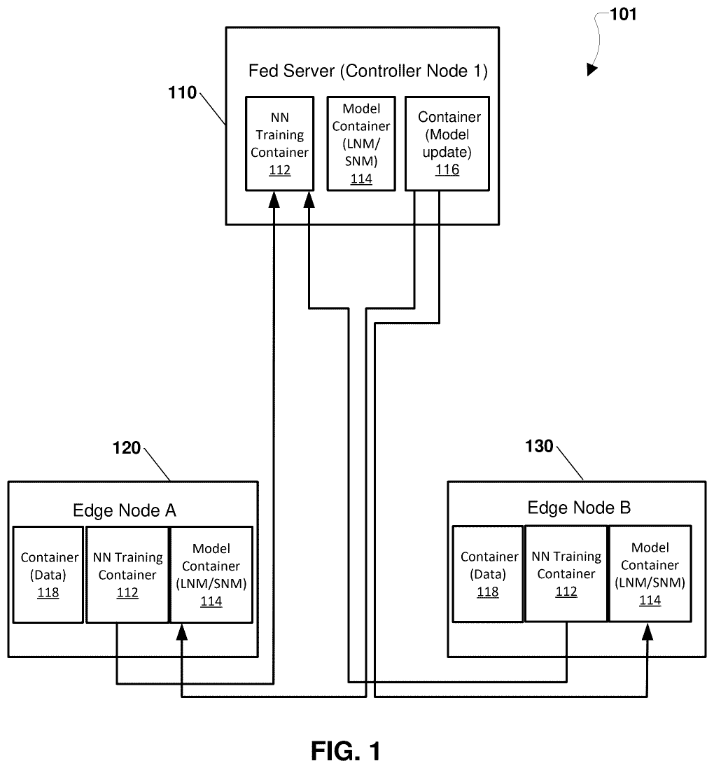

FIG. 1 illustrates a FedAvg and FedMD architecture 100 for edge computing nodes. In FIG. 1, edge node A 120 and edge node B 130 commence training using their respective data. This training may be synchronous or asynchronous. In synchronous training, all nodes begin and complete training simultaneously. If a node finishes its round of training early due to the size of its dataset, it may continue training until the predetermined time has elapsed.

A consideration in the FedAvg and FedMD architecture 101 shown in FIG. 1 involves the frequency of global model updates, referred to as the synchronization barrier. Low-frequency synchronization may lead to model degradation as the trainers' parameters fall out of sync with real-world data, resulting in slower convergence. This is particularly important when edge node A 120 and edge node B 130 are processing different local datasets that may evolve at different rates.

Conversely, high-frequency synchronization may accelerate model convergence but increase communication overhead between the Fed Server 110 and the edge nodes 120, 130. This increased communication can strain network resources, especially when multiple edge nodes are simultaneously transmitting model updates to the Fed Server 110.

In synchronous training within the architecture 101, each training round adheres to a fixed period ending with a rigid deadline. No trainer updates are considered after this deadline. If a node, such as edge node A 120, finishes early due to having a smaller dataset than edge node B 130, it may continue training until the defined time or steps are completed, ensuring all nodes contribute equally to each global update cycle.

In asynchronous training, each node trains based on events such as the arrival of new data in the Container (Data) 118, which can improve convergence, the receipt of a certain amount of data inputs, or the completion of a training round in the NN Training Container 112. Asynchronous training may exhibit slower and less accurate convergence with increased delays. Trainers may continue local training until a new model is released from the Fed Server 110. A new model is released when a minimum ratio of labor has been submitted, prompting trainers to update to the new model through the Model Container (LLM/SLM) 114.

In Federated Averaging (FedAvg) as implemented in the architecture 101 of FIG. 1, changes to the local models (LLM/SLM) at edge nodes (e.g., edge node A 120 or edge node B 130) may be sent to the Fed Server 110 through the Container (Model update) 116. These changes may be averaged to produce a new model, which may then be shared with all associated edge nodes. During the next training round, edge devices may pull the updated model from the Fed Server 110 into their respective Model Container (LLM/SLM) 114, repeating the process. This cyclical process enables continuous improvement of the model while maintaining data privacy since only model updates, not raw data, are shared between the edge nodes and the Fed Server.

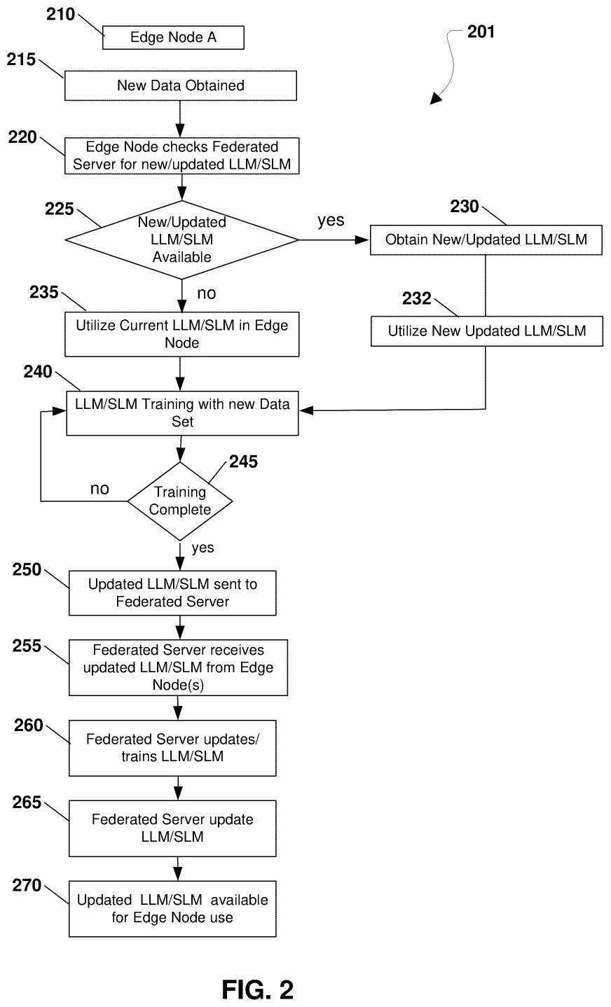

FIG. 2 illustrates training method 201, which comprises a comprehensive federated learning process that begins with Edge Node A (e.g., 120) obtaining new data and checking for updated models from a Federated Server. The method 201 may proceed through local model training using the new dataset, with iterative training rounds continuing until completion criteria are met. Upon successful training completion, the updated model parameters are transmitted to the Federated Server, which receives contributions from multiple edge nodes, aggregates these updates, and creates an improved global model that becomes available for distribution back to all participating edge nodes.

The overall purpose of method 201 is to enable distributed machine learning across multiple edge computing nodes while maintaining data privacy and reducing communication overhead. The method 201 may facilitate collaborative model improvement by allowing each edge node to contribute local training insights to a global model without sharing raw data, thereby achieving better model performance through collective learning while preserving data locality and privacy.

Examples of systems that may perform this method 201 may include edge computing nodes equipped with local processing capabilities such as industrial IoT gateways, autonomous vehicle computing units, smart city infrastructure nodes, manufacturing equipment controllers, and mobile edge computing servers. These systems may incorporate processors, memory, storage, and communication interfaces necessary for local data processing and model training operations.

Examples of systems that may interact with the apparatus performing the method 201 may include federated learning coordination servers that manage global model aggregation, blockchain networks that provide secure and immutable logging of model updates, cloud-based storage systems such as IPFS for distributed model storage, smart contract platforms that automate model distribution and validation processes, and various edge devices such as sensors, cameras, and monitoring equipment that provide input data to the edge computing nodes performing the training operations.

In block 210, the method 201 begins with Edge Node A initiating the data processing and model update sequence. Edge Node A represents one of the distributed computing nodes in the federated learning system that maintains local data storage and processing capabilities. The edge node serves as a point where data collection, preprocessing, and initial model training occur before participating in the broader federated learning process. Edge Node A may be equipped with various sensors, data collection mechanisms, or interfaces to gather information from its local environment. For example, Edge Node A could be deployed in a manufacturing facility collecting sensor data from production equipment, or in a smart city application gathering traffic and environmental data from local monitoring devices.

In block 215, the Edge Node A obtains new data for processing and training purposes. This data acquisition process may involve collecting information from connected sensors, receiving data streams from local devices, or gathering information from various input sources within the node's operational domain. The new data represents fresh information that can be used to update and improve the machine learning models running on the edge node. For example, in a predictive maintenance scenario, Edge Node A might collect vibration data from machinery, temperature readings from equipment, or operational parameters from industrial processes. The data collection process may be continuous or triggered by specific events, depending on the application requirements and the nature of the data sources.

In block 220, the Edge Node A checks the Federated Server for new or updated LLM/SLM models. This communication step involves the edge node querying the central federated server to determine if improved or modified models are available for download and deployment. The edge node may send a request containing information about its current model version, application requirements, or specific model parameters to help the server determine if updates are needed. For example, the edge node might send a query indicating it is currently running version 2.1 of a predictive analytics model and requesting information about any newer versions that may have been trained using data from other nodes in the federated network.

In determination block 225, the Edge Node A determines whether a new or updated LLM/SLM is available from the Federated Server. This evaluation process involves analyzing the response received from the server to assess if model updates are present and suitable for the edge node's current application needs. The determination may consider factors such as model version numbers, compatibility requirements, performance improvements, or specific feature enhancements that align with the node's operational objectives. For example, the edge node might evaluate whether a new model version offers improved accuracy for its specific use case, or whether the updated model includes new capabilities that enhance its local processing functions.

In response to the Edge Node A determining that a new or updated LLM/SLM is available (i.e., determination block 225=“Yes”), the Edge Node A obtains the new or updated LLM/SLM from the Federated Server in block 230. In response to the Edge Node A determining that no new or updated LLM/SLM is available (i.e., determination block 225=“No”), the Edge Node A utilizes the current LLM/SLM in the Edge Node in block 235.

In block 230, the Edge Node A obtains the new or updated LLM/SLM from the Federated Server. This process involves downloading the updated model parameters, weights, and configuration data from the central server to the local edge node storage. The edge node may receive the model through secure communication channels, ensuring data integrity and authenticity during the transfer process. The obtained model may include updated neural network weights, revised training parameters, or enhanced algorithms that have been developed through the collective learning process of the federated system. For example, the edge node might download an updated image recognition model that has been improved through training data contributed by multiple nodes across the network, resulting in better accuracy for local object detection tasks.

In block 232, Edge Node A implements the newly acquired or updated LLM or SLM for its computational and inferential operations. This integration allows the edge node to leverage the most current AI capabilities, potentially improving its performance across various tasks. The utilization of the new or updated model may involve reconfiguring the node's processing pipeline, adjusting input/output interfaces, and optimizing resource allocation to accommodate any changes in the model's architecture or computational requirements. By employing the latest version of the LLM/SLM, Edge Node A can enhance its ability to analyze data, make predictions, or generate outputs with potentially greater accuracy, efficiency, or relevance to its specific operational context. This step is crucial in maintaining the edge node's effectiveness within the broader federated learning ecosystem, ensuring that it contributes meaningfully to the collective intelligence of the network while benefiting from the aggregated knowledge encapsulated in the updated model.

In block 235, the Edge Node A utilizes the current LLM/SLM in the Edge Node for its processing and inference tasks. When no updated model is available, the edge node continues operating with its existing model, applying it to new data and generating predictions or classifications based on the current model parameters. This approach ensures continuous operation even when model updates are not immediately available. The current model may have been previously trained on local data or received from earlier federated learning rounds. For example, if the edge node is performing anomaly detection in network traffic, it would continue using its existing trained model to analyze incoming data packets and identify potential security threats or unusual patterns.

In block 240, the Edge Node A performs LLM/SLM training with the new data set obtained in block 215. This training process involves using the newly collected data to update the model parameters, adjust weights and biases, and improve the model's performance for local conditions and requirements. The training may utilize various machine learning algorithms and optimization techniques to enhance the model's accuracy and effectiveness. The edge node applies the new data to either the updated model obtained in block 230 or the current model from block 235, depending on the path taken through the previous determination block. For example, in a smart agriculture application, the edge node might train its crop monitoring model using newly collected soil moisture, temperature, and growth data to improve its ability to predict optimal irrigation timing and crop health assessments.

In determination block 245, the Edge Node A determines whether the training process is complete. This evaluation involves assessing various training completion criteria such as convergence of model parameters, achievement of target accuracy levels, completion of predetermined training epochs, or satisfaction of other performance metrics. The determination may also consider computational resource constraints, time limitations, or specific application requirements that define when training should conclude. For example, the edge node might evaluate whether the model has achieved a target accuracy threshold of 95% for its classification task, or whether it has completed the specified number of training iterations without significant improvement in performance metrics.

In response to the Edge Node A determining that training is not complete (i.e., determination block 245=“No”), the Edge Node A continues LLM/SLM training with the new data set in block 240. In response to the Edge Node A determining that training is complete (i.e., determination block 245=“Yes”), the Edge Node A sends the updated LLM/SLM to the Federated Server in block 250.

In block 250, the Edge Node A sends the updated LLM/SLM to the Federated Server after completing the local training process. This transmission involves packaging the trained model parameters, weights, and relevant metadata for secure communication to the central server. The edge node may encrypt the model data and include information about training performance, data characteristics, or other relevant metrics that help the federated server understand the quality and applicability of the updated model. For example, the edge node might send its updated predictive maintenance model along with performance statistics, training data size, and accuracy metrics to help the federated server evaluate the contribution's value for global model aggregation.

In block 255, the Federated Server receives the updated LLM/SLM from Edge Node A and potentially other edge nodes participating in the federated learning process. The server collects these model updates from multiple distributed nodes, preparing them for aggregation and global model improvement. The reception process may involve validating the received models, checking data integrity, and organizing the updates for subsequent processing steps. The federated server may receive updates from various edge nodes simultaneously or at different times, depending on the synchronization approach used in the system. For example, the server might collect updated traffic prediction models from edge nodes deployed across different city intersections, each contributing local traffic pattern knowledge to improve the overall traffic management system.

In block 260, the Federated Server updates and trains the global LLM/SLM using the received model updates from the edge nodes. This process involves aggregating the individual model contributions using techniques such as federated averaging, weighted aggregation, or other federated learning algorithms. The server combines the knowledge gained from multiple edge nodes to create an improved global model that benefits from the diverse data and training experiences across the distributed network. The aggregation process may consider factors such as the quality of individual contributions, the amount of training data used by each node, or the performance metrics achieved during local training. For example, the server might aggregate anomaly detection models from multiple industrial facilities, combining their collective knowledge about equipment failures and operational patterns to create a more robust global model.

In block 265, the Federated Server finalizes the updated global LLM/SLM after completing the aggregation and training process. This step involves validating the aggregated model, performing quality checks, and preparing the updated model for distribution back to the edge nodes. The server may conduct testing to ensure the global model maintains or improves upon previous performance levels and meets the requirements for deployment across the federated network. The finalization process may also include optimizing the model for edge deployment, ensuring compatibility with various edge node configurations, and preparing documentation or metadata that describes the model's capabilities and requirements. For example, the server might finalize an updated language processing model that incorporates improvements from multiple edge nodes, ensuring it maintains high performance while being suitable for deployment on resource-constrained edge devices.

In block 270, the updated LLM/SLM becomes available for Edge Node use, completing the federated learning cycle. The federated server makes the improved global model accessible to all participating edge nodes, enabling them to download and deploy the enhanced model for their local applications. This availability may be communicated through various mechanisms such as notifications, periodic checks, or push updates, depending on the system's communication architecture. The updated model represents the collective learning from the entire federated network, potentially offering improved accuracy, enhanced capabilities, or better performance compared to previous versions. For example, edge nodes in a distributed healthcare monitoring system might access an updated patient monitoring model that has been improved through federated learning across multiple hospitals, providing better diagnostic capabilities while maintaining patient privacy through the federated approach.

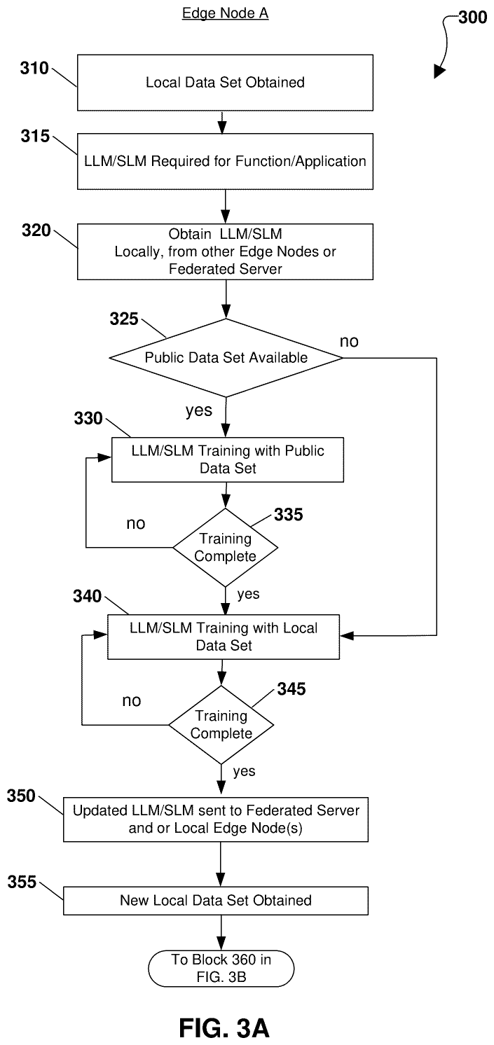

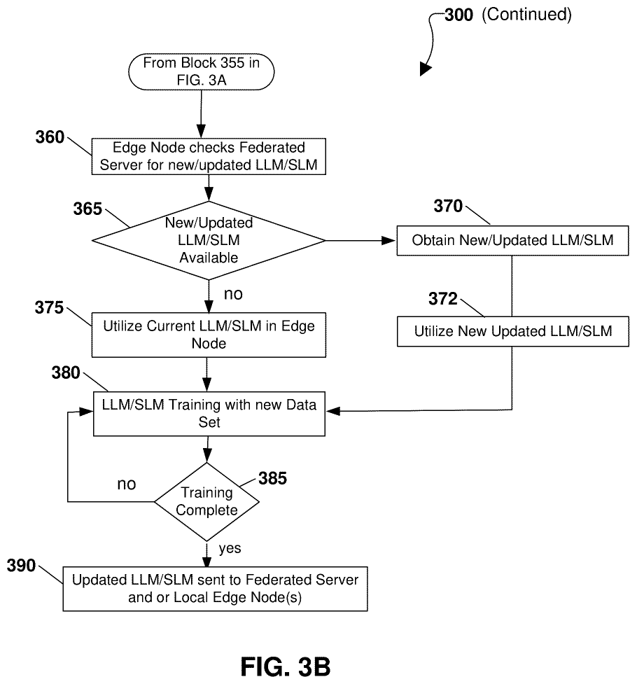

In Federated Model Distillation (FedMD), as illustrated in FIGS. 3A and 3B, edge nodes may first train their local models using a public dataset if available, then with their own local data. After completing local training, the edge nodes send their updated model parameters to the federated server and/or other local edge nodes. The changes may be averaged to create a new global model, which may be shared with all associated edge nodes. The edge nodes then obtain new local data and check the federated server for new or updated models. If a new or updated model is available, the edge nodes obtain it; otherwise, they continue using their current model. The next training round involves edge devices performing additional training with new datasets before sending the refined models back to the federated infrastructure, repeating the process in a continuous learning cycle that maintains data privacy while optimizing model performance through collaborative improvement.

FIGS. 3A and 3B illustrate training method 300, which comprises a comprehensive federated learning process that begins with obtaining local data and determining the appropriate LLM/SLM required for the specific function or application. The method 300 proceeds through obtaining the necessary model from local sources, other edge nodes, or a federated server, followed by optional training with public datasets if available. The process continues with local model training using the node's specific dataset, with iterative training rounds continuing until completion criteria are met. Upon successful training completion, the updated model parameters are transmitted to the federated server and/or local edge nodes, after which new local data is obtained to continue the learning cycle. The method 300 then incorporates a model update phase where edge nodes check for new or updated models from the federated server, obtain updated models when available, and perform additional training with new datasets before distributing the refined models back to the federated infrastructure.

The overall purpose of method 300 is to enable distributed machine learning across multiple edge computing nodes while maintaining data privacy and optimizing model performance through continuous learning and adaptation. The method facilitates collaborative model improvement by allowing each edge node to contribute local training insights to a global model ecosystem without compromising data locality, thereby achieving better model performance through collective learning while preserving privacy and reducing communication overhead.

Examples of systems that may perform this method 300 may include edge computing nodes equipped with local processing capabilities such as industrial IoT gateways, autonomous vehicle computing units, smart city infrastructure nodes, manufacturing equipment controllers, mobile edge computing servers, and distributed sensor networks. These systems may incorporate processors, memory, storage, and communication interfaces necessary for local data processing, model training operations, and federated learning participation.

Examples of systems that may interact with the apparatus performing the method 300 may include federated learning coordination servers that manage global model aggregation and distribution, blockchain networks that provide secure and immutable logging of model updates, cloud-based storage systems and IPFS networks for distributed model storage and retrieval, smart contract platforms that automate model distribution and validation processes, public dataset repositories that provide training data for initial model development, and various edge devices such as sensors, cameras, monitoring equipment, and IoT devices that provide input data to the edge computing nodes performing the training operations.

Split learning may involve dividing the neural network into two parts: the server part and the device part. Each device may use a common model, and a single server model processes activations from all devices. Devices may calculate activations for their private data and send these, along with labels, to the server. The server may calculate the gradients and send them back to the devices, repeating the process. The primary advantages of split learning are high convergence speed and reduced computational burden on end devices. However, these benefits may result in increased network communication due to the frequency of computations.

In block 310, the edge node obtains local data for processing and model training purposes. This data acquisition process involves collecting information from various sources within the edge node's operational environment, such as sensors, connected devices, or local databases. The local data represents the unique information available at the specific edge location and forms the foundation for subsequent model training activities. The data collection may be continuous or event-driven, depending on the application requirements and the nature of the data sources. For example, in an industrial monitoring scenario, the edge node might collect vibration data from machinery, temperature readings from equipment sensors, or operational parameters from production line controllers. In a smart city application, the edge node could gather traffic flow data from intersection cameras, air quality measurements from environmental sensors, or pedestrian count information from monitoring devices.

In block 315, the edge node determines which LLM/SLM is required for the function or application. This determination process involves analyzing the specific requirements of the intended application and selecting the appropriate model type that can effectively process the collected local data. The selection may consider factors such as the complexity of the task, the computational resources available at the edge node, and the specific domain knowledge required for the application. The edge node may evaluate different model options based on their performance characteristics, resource requirements, and suitability for the particular use case. For example, a predictive maintenance application might require a specialized smaller learning model trained specifically for equipment failure detection, while a natural language processing task might need a more general large language model with broader linguistic capabilities.

In block 320, the edge node obtains the LLM/SLM locally, from other edge nodes, or from a federated server. This acquisition process involves retrieving the selected model from the most appropriate source based on availability, network conditions, and system architecture. The edge node may first check its local storage for cached models, then query neighboring edge nodes for model sharing opportunities, and finally contact the federated server if the model is not available locally. The model retrieval process may include downloading model parameters, weights, configuration files, and any associated metadata required for proper model operation. For example, an edge node in a distributed manufacturing network might obtain a quality control model from a neighboring node that has already been trained on similar production data, or it might download a general-purpose model from the central federated server and then customize it with local training data.

In determination block 325, the edge node determines whether a public data set is available for initial model training. This evaluation involves checking for publicly accessible datasets that can be used to pre-train or initialize the model before applying local data. Public datasets may provide a broader foundation of knowledge that can improve the model's initial performance and reduce the amount of local training required. The availability of public datasets may depend on the specific application domain, data licensing agreements, and network connectivity to external data repositories. The edge node may assess the relevance and quality of available public datasets to determine their suitability for the intended application.

In response to the edge node determining that a public data set is available (i.e., determination block 325=“Yes”), the edge node performs LLM/SLM training with the public data set in block 330. In response to the edge node determining that no public data set is available (i.e., determination block 325=“No”), the edge node performs LLM/SLM training with the local data set in block 340.

In block 330, the edge node performs LLM/SLM training with the public data set. This training process involves using the publicly available data to establish initial model parameters and provide a foundation of general knowledge before applying local data. The public dataset training may help the model develop basic patterns and relationships that can be refined with local data in subsequent training phases. The training process may involve multiple epochs and optimization techniques to ensure the model effectively learns from the public data. For example, an edge node deployed for image recognition tasks might use a public dataset of general images to train the initial layers of a neural network, establishing basic feature detection capabilities that can later be specialized for the specific objects or scenes encountered in the local environment.

In determination block 335, the edge node determines whether training with the public data set is complete. This evaluation involves assessing various completion criteria such as convergence of model parameters, achievement of target performance metrics, or completion of predetermined training epochs. The determination may consider computational resource constraints, time limitations, or specific performance thresholds that indicate when the public dataset training phase should conclude. The edge node may monitor training progress through loss functions, accuracy measurements, or other relevant performance indicators to determine when sufficient learning has occurred from the public data.

In response to the edge node determining that training with the public data set is complete (i.e., determination block 335=“Yes”), the edge node performs LLM/SLM training with the local data set in block 340. In response to the edge node determining that training with the public data set is not complete (i.e., determination block 335=“No”), the edge node continues LLM/SLM training with the public data set in block 330.

In block 340, the edge node performs LLM/SLM training with the local data set. This training process involves using the locally collected data to customize and refine the model for the specific conditions and requirements of the edge node's operational environment. The local training may build upon any previous training performed with public datasets or may represent the primary training phase if no public data was available. The training process applies machine learning algorithms and optimization techniques to adjust model parameters based on the characteristics and patterns present in the local data. For example, an edge node in a smart agriculture system might train its crop monitoring model using locally collected soil moisture, temperature, and growth data to optimize predictions for the specific crop types, soil conditions, and climate patterns present at that particular farm location.

In determination block 345, the edge node determines whether training with the local data set is complete. This evaluation involves assessing completion criteria specific to the local training phase, such as convergence of model parameters on local data patterns, achievement of target accuracy levels for local conditions, or satisfaction of application-specific performance requirements. The determination may also consider resource constraints, time limitations, or diminishing returns in training improvement that indicate when local training should conclude. The edge node may evaluate whether the model has achieved sufficient accuracy for its intended local application or whether additional training iterations would provide meaningful improvements.

In response to the edge node determining that training with the local data set is complete (i.e., determination block 345=“Yes”), the edge node sends the updated LLM/SLM to the federated server and/or local edge nodes in block 350. In response to the edge node determining that training with the local data set is not complete (i.e., determination block 345=“No”), the edge node continues LLM/SLM training with the local data set in block 340.

In block 350, the edge node sends the updated LLM/SLM to the federated server and/or local edge nodes. This transmission process involves packaging the trained model parameters, weights, and relevant metadata for secure communication to other nodes in the federated learning network. The edge node may encrypt the model data and include information about training performance, data characteristics, convergence metrics, or other relevant information that helps recipients understand the quality and applicability of the updated model. The distribution may target the central federated server for global model aggregation, neighboring edge nodes for peer-to-peer model sharing, or both depending on the network architecture and communication protocols. For example, an edge node that has successfully trained a traffic prediction model using local intersection data might share its updated model with nearby traffic management nodes and also contribute it to the central server for incorporation into a city-wide traffic optimization system.

In block 355, the edge node obtains a new local data set for continued learning and model improvement. This data acquisition process involves collecting fresh information from the local environment to support ongoing model training and adaptation. The new data may represent recent observations, updated conditions, or additional samples that can further enhance the model's performance and accuracy. The continuous data collection enables the edge node to adapt to changing conditions and maintain model relevance over time. For example, an edge node monitoring equipment performance might collect new sensor readings that reflect seasonal changes, equipment aging, or operational modifications that require model updates to maintain accurate predictions.

In block 360, the edge node checks the federated server for new or updated LLM/SLM models. This communication process involves querying the central server to determine if improved or modified models are available for download and deployment. The edge node may send requests containing information about its current model version, application requirements, or specific performance needs to help the server determine if updates are beneficial. The check may be performed periodically, triggered by specific events, or initiated based on performance degradation of the current model. For example, an edge node running a language processing application might check the federated server weekly to see if a new model version has been trained that incorporates improvements from other nodes in the network, potentially offering better accuracy or new capabilities for local text processing tasks.

In determination block 365, the edge node determines whether a new or updated LLM/SLM is available from the federated server. This evaluation involves analyzing the response received from the server to assess if model updates are present and suitable for the edge node's current application needs. The determination may consider factors such as model version numbers, compatibility requirements, performance improvements, or specific feature enhancements that align with the node's operational objectives. The edge node may also evaluate whether the new model offers sufficient improvements to justify the resources required for downloading and deploying the update.

In response to the edge node determining that a new or updated LLM/SLM is available (i.e., determination block 365=“Yes”), the edge node obtains the new or updated LLM/SLM in block 370. In response to the edge node determining that no new or updated LLM/SLM is available (i.e., determination block 365=“No”), the edge node utilizes the current LLM/SLM in the edge node in block 375.

In block 370, the edge node obtains the new or updated LLM/SLM from the federated server. This process involves downloading the updated model parameters, weights, and configuration data from the central server to the local edge node storage. The edge node may receive the model through secure communication channels, ensuring data integrity and authenticity during the transfer process. The obtained model may include updated neural network weights, revised training parameters, or enhanced algorithms that have been developed through the collective learning process of the federated system. For example, the edge node might download an updated anomaly detection model that has been improved through training data contributed by multiple nodes across the network, resulting in better accuracy for identifying unusual patterns in local sensor data.

In block 372, the edge node utilizes the new/updated LLM/SLM in the edge node for processing and inference tasks.

In block 375, the edge node utilizes the current LLM/SLM in the edge node for its processing and inference tasks. When no updated model is available, the edge node continues operating with its existing model, applying it to new data and generating predictions or classifications based on the current model parameters. This approach ensures continuous operation even when model updates are not immediately available. The current model may have been previously trained on local data or received from earlier federated learning rounds. For example, if the edge node is performing predictive maintenance on industrial equipment, it would continue using its existing trained model to analyze incoming sensor data and identify potential equipment failures or maintenance needs.

In block 380, the edge node performs LLM/SLM training with the new data set obtained in block 355. This training process involves using the newly collected data to update the model parameters, adjust weights and biases, and improve the model's performance for current conditions and requirements. The training may utilize various machine learning algorithms and optimization techniques to enhance the model's accuracy and effectiveness. The edge node applies the new data to either the updated model obtained in block 370 or the current model from block 375, depending on the path taken through the previous determination block. For example, in a smart building management system, the edge node might train its energy optimization model using newly collected occupancy patterns, temperature data, and energy consumption measurements to improve its ability to predict optimal heating and cooling schedules.

In determination block 385, the edge node determines whether training with the new data set is complete. This evaluation involves assessing various training completion criteria such as convergence of model parameters, achievement of target accuracy levels, completion of predetermined training epochs, or satisfaction of other performance metrics. The determination may also consider computational resource constraints, time limitations, or specific application requirements that define when training should conclude. The edge node may evaluate whether the model has achieved sufficient improvement in performance metrics or whether additional training iterations would provide diminishing returns.

In response to the edge node determining that training with the new data set is complete (i.e., determination block 385=“Yes”), the edge node sends the updated LLM/SLM to the federated server and/or local edge nodes in block 390. In response to the edge node determining that training with the new data set is not complete (i.e., determination block 385=“No”), the edge node continues LLM/SLM training with the new data set in block 380.

In block 390, the edge node sends the updated LLM/SLM to the federated server and/or local edge nodes after completing the training process with the new data set. This transmission involves packaging the trained model parameters, weights, and relevant metadata for secure communication to other nodes in the federated learning network. The edge node may encrypt the model data and include information about training performance, data characteristics, or other relevant metrics that help recipients understand the quality and applicability of the updated model. The distribution enables the sharing of locally learned knowledge with the broader federated network, contributing to collective model improvement while maintaining data privacy. For example, an edge node that has refined its weather prediction model using recent local meteorological data might share its updated model with regional weather monitoring nodes and contribute it to the central server for incorporation into broader climate modeling systems.

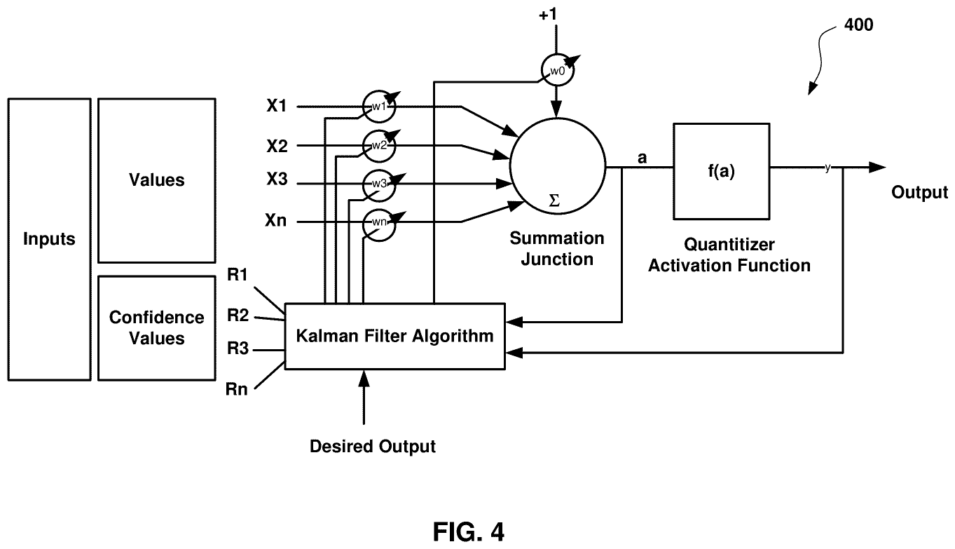

In FIG. 4, the processing system 400 integrates a Kalman filter into the training process used by both the Fed Server and the Edge Node.

The processing system may use the Kalman filter, with its covariance matrix, to set weights and biases during initial training and continuous learning. By employing the Kalman filter, the system determines weights and biases either independently or in conjunction with other AI functions and architectures. The Kalman filter helps discard lower confidence information used for node weight setting, preventing gradient skewing and reducing the time required to reach optimal decisions. The Kalman Filter Algorithm may be integrated into a comprehensive Predictive Holistic Inference Logic (PHIL) (e.g., method 500) that begins with selecting an appropriate LLM/SLM matching the required AI function.

The processing system may include confidence information managed by the covariance matrix, allowing for differential weighting of each training model input. Instead of averaging all training model inputs, the Kalman filter's covariance matrix adjusts the weight of each input based on its confidence level.

The processing system may integrate the Kalman filter algorithm, part of the training module referred to as Predictive Holistic Inference Logic (PHIL), within the training module or another module where new data is processed before training initiation. The covariance matrix functions as a secondary weighting mechanism for the primary weights.

Furthermore, following each training iteration, a Kalman filter mechanism updates the covariance matrix. The controller node subsequently records this newly updated covariance matrix onto a fresh blockchain block, updating a designated blockchain pointer (e.g., matrix_pointer) to reflect this latest state. Notably, this approach prevents the complete weight set from leaving the controller node, enhancing both security and computational efficiency.

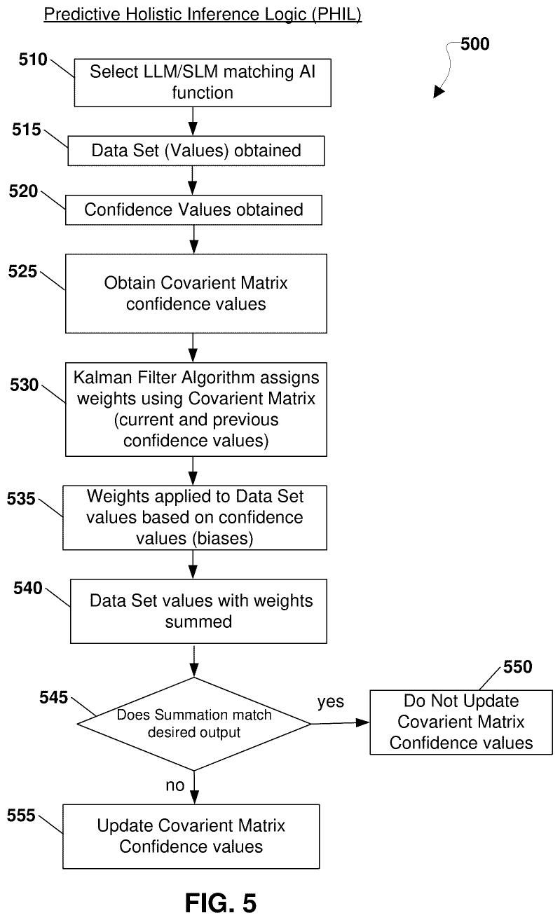

FIG. 5 illustrates method 500, which comprises a comprehensive Predictive Holistic Inference Logic (PHIL) process that begins with selecting an appropriate LLM/SLM matching the required AI function, followed by obtaining a dataset containing values and their corresponding confidence values. The method proceeds to obtain covariance matrix confidence values that capture statistical relationships between different variables in the dataset. A Kalman Filter Algorithm then assigns weights using the covariance matrix, incorporating both current and previous confidence values to dynamically adjust the importance of different data elements. The process applies these weights to the dataset values based on confidence values and biases, then sums the weighted dataset values to produce an aggregate result. The method includes a feedback mechanism that determines whether the summation matches the desired output, and based on this evaluation, either maintains the current covariance matrix confidence values or updates them to improve future performance.

The overall purpose of method 500 may be used to implement an adaptive training and inference system that optimizes neural network performance by incorporating confidence-based weighting mechanisms. The method aims to improve model accuracy and convergence speed by filtering out lower confidence information and preventing gradient skewing, while enabling continuous learning and adjustment of weights and biases based on data reliability and historical performance patterns.

Examples of systems that may perform method 500 include edge computing nodes equipped with local processing capabilities such as industrial IoT gateways performing predictive maintenance on manufacturing equipment, autonomous vehicle computing units processing sensor fusion data, smart city infrastructure nodes analyzing traffic and environmental patterns, medical diagnostic systems evaluating patient vital signs from multiple monitoring devices, and financial risk assessment platforms processing economic indicators with varying reliability levels. These systems may incorporate processors, memory, storage, and specialized AI/ML accelerators necessary for implementing Kalman filtering algorithms and neural network training operations.

Examples of systems that may interact with the apparatus performing method 500 include sensor networks and data acquisition systems that provide input datasets with associated confidence metrics, calibration systems that establish initial confidence values for different data sources, external databases and cloud services that supply historical performance data for covariance matrix initialization, validation systems that provide desired output references for training feedback, and monitoring platforms that track model performance and trigger confidence value adjustments based on real-world results and changing operational conditions.

In block 510, the processing system selects an LLM/SLM matching AI function. This selection process involves identifying and choosing the appropriate large language model or smaller learning model that aligns with the specific artificial intelligence function required for the current application or task. The processing system may evaluate various available models based on their capabilities, computational requirements, and suitability for the intended use case. The selection may consider factors such as model size, training data characteristics, performance metrics, and resource constraints of the edge computing environment. For example, a processing system deployed in an industrial monitoring application might select a smaller learning model specifically trained for equipment failure prediction rather than a general-purpose large language model, as the SLM would be more efficient and targeted for the specific predictive maintenance tasks required in that environment.

In block 515, the processing system obtains a data set containing values. This data acquisition process involves collecting and organizing the input data that will be used for training or inference operations with the selected model. The data set may contain various types of information relevant to the specific application, including sensor readings, historical records, real-time measurements, or other structured data elements. The processing system may gather this data from local storage, connected devices, external databases, or streaming data sources depending on the application requirements. For example, in a smart city traffic management system, the processing system might obtain a data set containing traffic flow measurements, vehicle counts, signal timing data, and weather conditions from various sensors and monitoring devices throughout the urban area.

In block 520, the processing system obtains confidence values. This process involves acquiring or calculating confidence metrics that indicate the reliability, accuracy, or trustworthiness of the data elements in the data set. Confidence values may be derived from various sources, including sensor accuracy specifications, historical performance data, data quality assessments, or statistical analysis of the input information. These confidence values serve as indicators of how much weight should be given to each data element during the processing and decision-making operations. For example, in a weather prediction system, confidence values might be assigned based on the age of meteorological data, with recent measurements receiving higher confidence values than older historical data, or based on the known accuracy of different weather monitoring stations.

In block 525, the processing system obtains covariance matrix confidence values. This operation involves acquiring or computing the covariance matrix elements that represent the statistical relationships and confidence levels between different variables in the data set. The covariance matrix confidence values provide information about how different data elements correlate with each other and their relative reliability in the context of the overall system. These values may be calculated based on historical data analysis, statistical modeling, or predefined relationships between variables. The covariance matrix helps the system understand not just individual data point confidence but also the interdependencies and correlations between multiple data elements. For example, in a financial risk assessment system, the covariance matrix might capture the relationships between different economic indicators, showing how changes in interest rates correlate with stock market performance and how confident the system is in these relationships.

In block 530, the processing system uses a Kalman Filter Algorithm to assign weights using the Covariance Matrix, incorporating both current and previous confidence values. This process involves applying the Kalman filtering technique to dynamically adjust the importance or influence of different data elements based on their confidence levels and historical performance. The Kalman Filter Algorithm processes the covariance matrix to determine optimal weighting factors that account for both the current reliability of data sources and their historical accuracy patterns. The algorithm may continuously update these weights as new data becomes available and as confidence levels change over time. For example, in an autonomous vehicle navigation system, the Kalman Filter Algorithm might assign higher weights to GPS data when satellite reception is strong and lower weights when the vehicle is in an urban canyon with poor signal quality, while simultaneously considering the historical accuracy of different positioning sensors.

In block 535, the processing system applies weights to Data Set values based on confidence values (biases). This operation involves multiplying or adjusting each data element in the data set according to the weights determined by the Kalman Filter Algorithm. The application of weights effectively scales the influence of each data point based on its associated confidence level, ensuring that more reliable data has greater impact on the final results while less reliable data contributes proportionally less. This weighting process may also incorporate bias adjustments that account for systematic errors or known limitations in specific data sources. For example, in a medical diagnostic system, patient vital signs from a high-precision monitoring device might receive full weight, while readings from a consumer-grade fitness tracker might be weighted at 60% of their original value due to known accuracy limitations.

In block 540, the processing system sums the Data Set values with weights. This summation process involves combining all the weighted data elements to produce an aggregate value that represents the collective input to the system. The weighted summation ensures that the final result reflects not just the raw data values but also their relative reliability and importance as determined by the confidence-based weighting system. The summation may involve simple addition for linear systems or more complex mathematical operations for non-linear relationships between data elements. For example, in a power grid load forecasting system, the weighted sum might combine electricity consumption data from various sources, with smart meter readings receiving higher weights than estimated consumption values, resulting in a more accurate overall load prediction.

In determination block 545, the processing system determines whether the summation matches desired output. This evaluation process involves comparing the weighted sum result against a target value, expected outcome, or acceptable range to assess whether the current processing has achieved the intended goal. The determination may involve exact matching, threshold-based comparisons, or statistical analysis to evaluate the closeness between the actual and desired results. The processing system may consider various criteria such as accuracy tolerances, performance thresholds, or application-specific requirements when making this determination. For example, in a temperature control system, the processing system might compare the weighted sum of sensor readings against a target temperature setpoint, determining that the summation matches the desired output if the calculated temperature is within 0.5 degrees of the target value.

In response to the processing system determining that the summation matches desired output (i.e., determination block 545=“Yes”), the processing system does not update the Covariance Matrix Confidence values in block 550. In response to the processing system determining that the summation does not match desired output (i.e., determination block 545=“No”), the processing system updates the Covariance Matrix Confidence values in block 555.

In block 550, the processing system does not update the Covariance Matrix Confidence values. This maintenance operation involves preserving the current covariance matrix values and confidence levels since the system has achieved satisfactory results with the existing parameters. By not updating these values, the processing system maintains stability in its weighting mechanisms and avoids unnecessary adjustments that could potentially degrade performance. The decision to maintain current values indicates that the existing confidence relationships and statistical correlations are performing adequately for the current application requirements. For example, in a quality control system for manufacturing, if the weighted analysis correctly identifies product defects within acceptable accuracy limits, the system would maintain its current confidence matrix to preserve the successful detection parameters.

In block 555, the processing system updates the Covariance Matrix Confidence values. This adjustment process involves modifying the covariance matrix elements and associated confidence levels to improve future performance based on the observed discrepancy between actual and desired results. The update mechanism may use various algorithms such as gradient descent, recursive least squares, or adaptive filtering techniques to adjust the confidence values in a direction that should reduce future errors. The updates may affect individual confidence values, correlation coefficients between variables, or the overall structure of the covariance matrix depending on the nature of the performance gap. For example, in a speech recognition system, if the weighted audio analysis fails to correctly identify spoken words, the system might reduce confidence values for audio channels with high background noise while increasing confidence for clearer audio sources, thereby improving future recognition accuracy.

The processing system may assign a weight or confidence number to updates to the LLM/SLM received from each edge node during the model update process, reflecting the edge device's assessment of the data's merit. Data that is not a perfect match will have a lower confidence interval, helping prevent bias and ensuring convergence is not based on a small data set meeting a threshold.

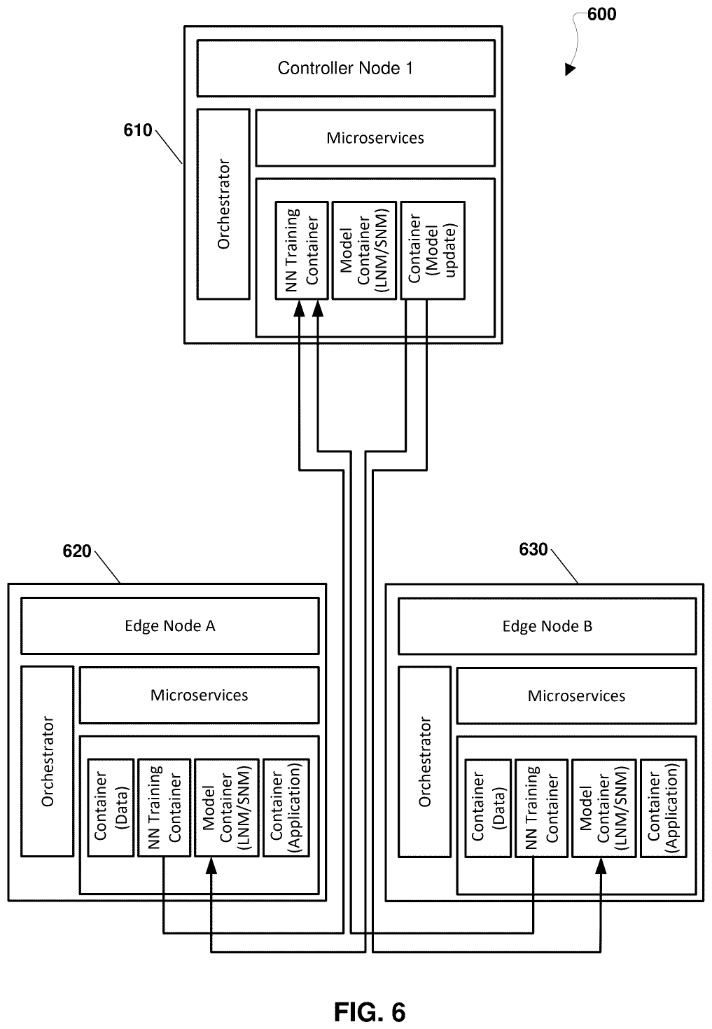

FIG. 6 illustrates a three-node network 600 that the processing system interconnects via wireless, wired, or a combination of both. The AI/ML learning components operate within a container environment, with certain functions running in individual containers. In the example illustrated in FIG. 6, the processing system may separate the training container from the model container within the Federated Learning (FL) system. The model container may contain a large language model (LLM) or a specialized learning model (SLM). The SLM, designed for specific tasks or functions, is less generalized than a typical LLM. The system configures the LLM to represent a large network model or a variant tailored to the localized network's needs, used for tasks such as enhancing resiliency, managing alternative WANs, or adjusting network components to meet specific requirements.

The three-node network 600 shown in FIG. 6 enables a comprehensive training and model update process. In this architecture, edge node A 620 and edge node B 630 can obtain data for training LLM/SLM models used for specific applications. Each edge node 620, 630 may commence training using its NN Training Container, leveraging local data sets to develop models tailored to local conditions and requirements. Upon completing the training process, edge nodes store the newly trained Application LLM/SLM locally before sharing updates with the controller node 1 610.

The LLM/SLM used by edge node A 620 and edge node B 630 may be the same or different LLM/SLMs depending on the application requirements. This flexibility in model selection allows the system to adapt to diverse application requirements across different edge nodes. For instance, edge node A 620 might utilize a larger, more comprehensive language model for complex natural language processing tasks, while edge node B 630 could employ a smaller, specialized learning model optimized for rapid inference in a specific domain like image recognition or sensor data analysis. The ability to deploy different LLM/SLMs on each edge node enables efficient resource allocation and tailored performance optimization based on the unique computational capabilities and task requirements of each node. Furthermore, this approach supports the heterogeneous nature of edge computing environments, where devices may have varying hardware specifications and operational constraints. By allowing for the use of either identical or distinct models across nodes, the system can balance workload distribution, minimize redundancy, and maximize the overall efficiency of the federated learning process.

Controller Node 1 610 in FIG. 6 may play a role by querying edge nodes for updates regarding their Application LLM/SLM models. When edge nodes send their newly trained models to the controller node, it commences a secondary training phase using its own NN Training Container. This process aggregates insights from multiple edge nodes, creating an improved global model that incorporates distributed learning from across the network. After completing this aggregation training, the controller node updates the appropriate Application LLM/SLM Model and makes it available for all edge nodes to use, enabling a synchronized improvement cycle throughout the network.

The architecture can be further enhanced to incorporate covariance matrix values for each layer of the neural network models. In this advanced implementation, edge nodes not only train basic models but also compute layer-specific covariance matrices that capture statistical relationships and confidence levels in the trained parameters. When queried by the controller node, edge nodes can send these covariance matrix values along with their model updates, enabling more sophisticated model aggregation at the controller level. The controller node can then perform statistical aggregation of these matrices, producing a global model with enhanced uncertainty quantification and confidence measures. This approach improves model robustness and performance by incorporating statistical confidence information throughout the federated learning process.

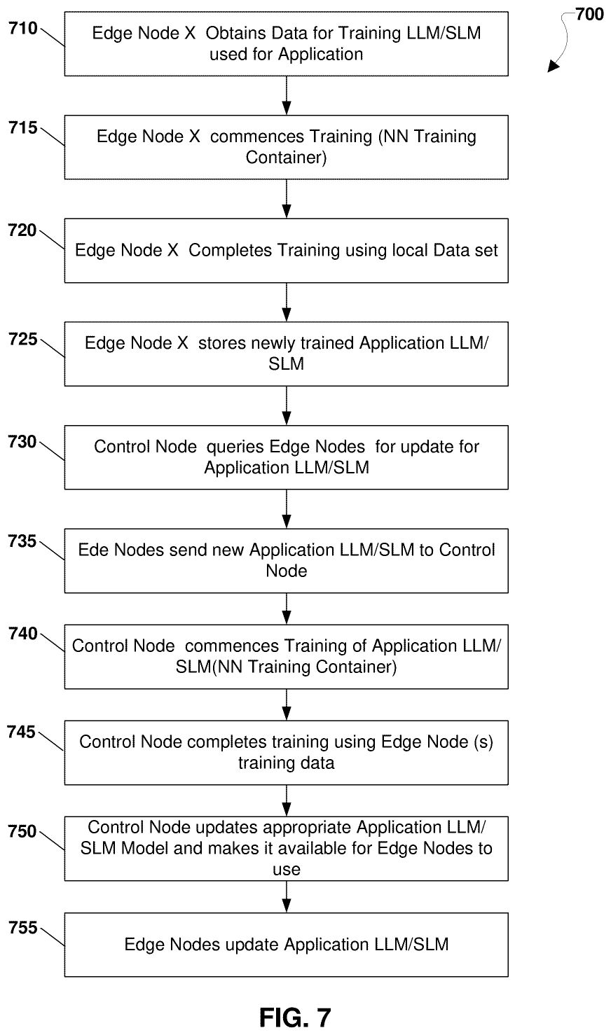

FIG. 7 illustrates a flowchart showing a method 700 for training and updating an LLM/SLM model in a federated learning environment. The method comprises a comprehensive process that begins with an edge node obtaining data for training, commencing and completing local training, and storing the trained model. The process continues with a control node querying edge nodes for updates, receiving new models from the edge nodes, commencing and completing training using the aggregated edge node data, updating the global model, and making it available for edge nodes to use. Finally, the edge nodes update their local models with the improved global version. The overall purpose of this method is to enable collaborative model improvement across distributed computing nodes while maintaining data privacy and reducing communication overhead by sharing only model updates rather than raw data (complete LLM/SLM). Examples of systems that may perform this method include edge computing nodes equipped with local processing capabilities such as industrial IoT gateways, autonomous vehicle computing units, smart city infrastructure nodes, and manufacturing equipment controllers. Examples of systems that may interact with the apparatus performing the method include federated learning coordination servers, blockchain networks for secure model logging, cloud-based storage systems, smart contract platforms, and various edge devices such as sensors and monitoring equipment that provide input data to the edge computing nodes.

In block 710, Edge Node X obtains data for training LLM/SLM used for an application. This data acquisition process involves collecting relevant information from local sources, sensors, or connected devices that will be used to train the machine learning model for a specific application. The edge node may gather various types of data depending on the application requirements, such as sensor readings, user interactions, environmental measurements, or operational parameters. The data collection process may be continuous or triggered by specific events, and the edge node may apply initial filtering or preprocessing to ensure data quality and relevance. For example, in an industrial monitoring application, Edge Node X might collect vibration data from machinery, temperature readings from equipment sensors, and operational status information from control systems to train a predictive maintenance model.

In block 715, Edge Node X commences training using a NN Training Container. This training initiation process involves starting the neural network training operations within a containerized environment that provides isolated and controlled execution of the machine learning algorithms. The NN Training Container encapsulates all the necessary components for model training, including the training algorithms, optimization functions, and computational resources required for the learning process. The containerized approach ensures consistent training environments and enables efficient resource management across different edge nodes. The training process may utilize various machine learning techniques such as supervised learning, unsupervised learning, or reinforcement learning depending on the application requirements and available data. For example, in a smart city traffic management system, the NN Training Container might implement deep learning algorithms to analyze traffic flow patterns and optimize signal timing based on real-time traffic data collected by the edge node.

In block 720, Edge Node X completes training using a local data set. This completion phase involves finalizing the neural network training process using the locally collected data, resulting in a trained model that reflects the specific characteristics and patterns present in the edge node's operational environment. The training completion may be determined by various criteria such as convergence of model parameters, achievement of target accuracy levels, completion of predetermined training epochs, or satisfaction of performance thresholds. The locally trained model incorporates knowledge specific to the edge node's environment and use case, which may differ from models trained on other nodes due to variations in local conditions, data distributions, or operational requirements. For example, in a manufacturing facility, Edge Node X might complete training of a quality control model that has learned to identify defects specific to the local production line's characteristics, material variations, and environmental conditions.

In block 725, Edge Node X stores the newly trained Application LLM/SLM. This storage operation involves saving the completed model parameters, weights, and configuration data in local storage systems for future use and potential sharing with other nodes in the federated learning network. The storage process may include model serialization, compression, and metadata generation to facilitate efficient storage and retrieval operations. The stored model represents the edge node's contribution to the federated learning process and contains the knowledge gained from local training data. The storage system may implement versioning capabilities to track different iterations of the model and enable rollback operations if needed. For example, in a healthcare monitoring system, Edge Node X might store a patient monitoring model that has been trained on local patient data, ensuring that the model parameters are preserved for continuous monitoring operations and potential contribution to a global healthcare model.

In block 730, a Control Node queries Edge Nodes for updates regarding the Application LLM/SLM. This querying process involves the central control node initiating communication with multiple edge nodes to request information about their locally trained models and any updates that may be available for aggregation. The control node may implement various communication protocols and scheduling mechanisms to efficiently collect model updates from distributed edge nodes without overwhelming the network or individual nodes. The query process may include requests for model parameters, training statistics, performance metrics, or metadata that helps the control node evaluate the quality and relevance of each edge node's contribution. For example, in a distributed environmental monitoring network, the Control Node might query edge nodes deployed across different geographic locations to collect updates from air quality prediction models that have been trained on local environmental data.

In block 735, the Edge Nodes send new Application LLM/SLM to the Control Node. This transmission process involves packaging and securely transferring the trained model data from multiple edge nodes to the central control node for aggregation and global model creation. The edge nodes may implement various data compression, encryption, and error correction techniques to ensure efficient and secure transmission of model parameters over potentially unreliable network connections. The transmission may include not only the model weights and parameters but also associated metadata such as training performance metrics, data quality indicators, and confidence measures that help the control node evaluate the contribution's value. For example, in an autonomous vehicle network, edge nodes from different vehicles might send their locally trained driving behavior models to the Control Node, including information about the driving conditions, road types, and weather patterns encountered during local training.

In block 740, the Control Node commences training of Application LLM/SLM using a NN Training Container. This centralized training initiation involves the control node beginning the process of aggregating and refining the received model updates from multiple edge nodes to create an improved global model. The NN Training Container at the control node may implement federated learning algorithms such as federated averaging, federated optimization, or other aggregation techniques that combine the knowledge from distributed edge nodes while maintaining data privacy. The training process may involve complex mathematical operations to merge model parameters, resolve conflicts between different node contributions, and optimize the global model performance. For example, in a smart grid management system, the Control Node might commence training to aggregate energy consumption prediction models from multiple edge nodes representing different neighborhoods, using federated learning techniques to create a comprehensive grid-wide prediction model.

In block 745, the Control Node completes training using Edge Node(s) training data. This completion phase involves finalizing the aggregation and optimization process to produce an updated global model that incorporates the collective knowledge from all participating edge nodes. The completion criteria may include convergence of the aggregation algorithm, achievement of target performance metrics, or satisfaction of predefined quality thresholds that ensure the global model meets the required standards. The completed global model represents a synthesis of knowledge from multiple edge nodes and may offer improved accuracy, generalization, or robustness compared to individual local models. For example, in a fraud detection system for financial services, the Control Node might complete training of a global fraud detection model that combines patterns learned from edge nodes at different bank branches, resulting in a more comprehensive model capable of detecting diverse fraud patterns across the entire network.

In block 750, the Control Node updates the appropriate Application LLM/SLM Model and makes it available for Edge Nodes to use. This distribution preparation process involves finalizing the global model, performing quality assurance checks, and preparing the updated model for deployment back to the edge nodes. The control node may implement model optimization techniques such as pruning, quantization, or compression to ensure the updated model is suitable for deployment on resource-constrained edge devices. The availability process may include updating model repositories, generating deployment packages, and creating distribution mechanisms that enable edge nodes to efficiently retrieve and deploy the updated model. For example, in a retail inventory management system, the Control Node might update a demand forecasting model that incorporates sales patterns from multiple store locations and make it available for deployment to all participating retail edge nodes.

In block 755, the Edge Nodes update their Application LLM/SLM. This final update process involves the edge nodes retrieving the improved global model from the control node and deploying it locally to replace or enhance their existing models. The update process may include model validation, compatibility checking, and gradual deployment strategies to ensure smooth transition from the old model to the new one without disrupting ongoing operations. The edge nodes may implement rollback mechanisms in case the updated model does not perform as expected in the local environment. The updated model enables the edge nodes to benefit from the collective learning of the entire federated network while maintaining their ability to perform local inference and decision-making. For example, in a predictive maintenance system for industrial equipment, edge nodes might update their equipment failure prediction models with the globally trained model that incorporates failure patterns learned from similar equipment across multiple industrial facilities, potentially improving their ability to predict and prevent equipment failures.

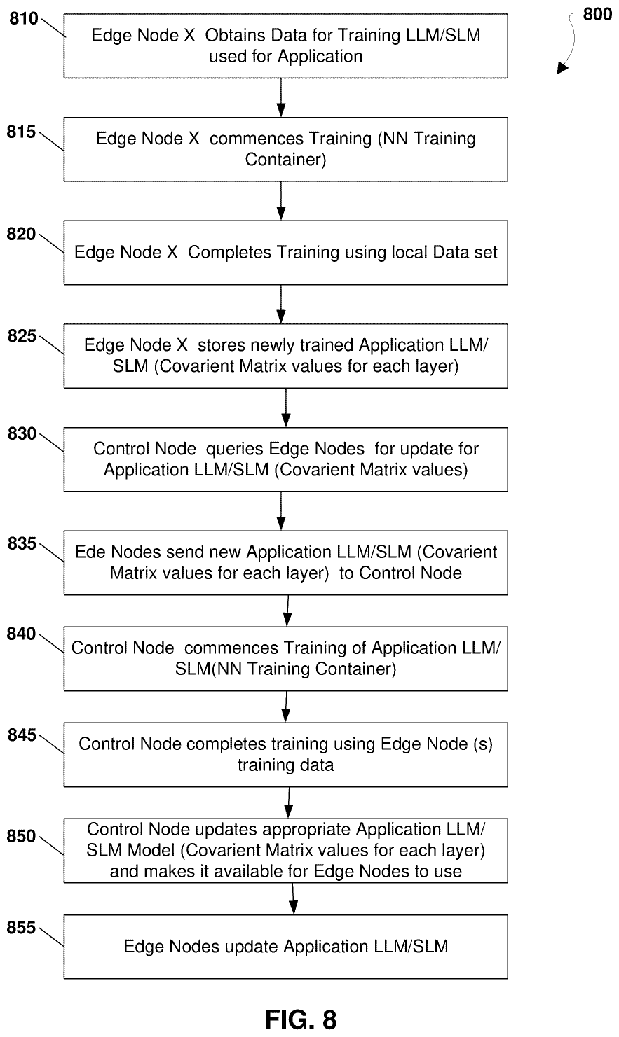

FIG. 8 illustrates method 800, which comprises a comprehensive federated learning process that incorporates covariance matrix values for enhanced model training and distribution. The method 800 begins with edge node data collection and proceeds through local training, covariance matrix storage, centralized aggregation, and global model distribution back to participating edge nodes. The process emphasizes the management and utilization of covariance matrix values for each layer of the neural network models, distinguishing it from standard federated learning approaches by incorporating statistical confidence measures and layer-specific parameter optimization.

In block 810, Edge Node X obtains data for training LLM/SLM used for an application. This data acquisition process involves collecting relevant information from local sources, sensors, or connected devices that will be used to train the machine learning model with covariance matrix considerations for a specific application. The edge node may gather various types of data depending on the application requirements, such as sensor readings with associated confidence levels, user interactions with reliability metrics, environmental measurements with accuracy indicators, or operational parameters with quality assessments. The data collection process may be continuous or triggered by specific events, and the edge node may apply initial filtering or preprocessing to ensure data quality and establish confidence values for subsequent covariance matrix calculations. For example, in an industrial monitoring application, Edge Node X might collect vibration data from machinery with sensor accuracy ratings, temperature readings from equipment sensors with calibration timestamps, and operational status information from control systems with reliability scores to train a predictive maintenance model that incorporates statistical confidence measures.

In block 815, Edge Node X commences training using a NN Training Container. This training initiation process involves starting the neural network training operations within a containerized environment that incorporates covariance matrix calculations for each layer of the neural network. The NN Training Container encapsulates all the necessary components for model training, including the training algorithms, optimization functions, covariance matrix computation modules, and computational resources required for the learning process with statistical confidence tracking. The containerized approach ensures consistent training environments and enables efficient resource management across different edge nodes while maintaining layer-specific covariance matrix values. The training process may utilize various machine learning techniques such as supervised learning with confidence weighting, unsupervised learning with uncertainty quantification, or reinforcement learning with action confidence measures depending on the application requirements and available data quality metrics. For example, in a smart city traffic management system, the NN Training Container might implement deep learning algorithms that calculate covariance matrices for each neural network layer to analyze traffic flow patterns with confidence measures and optimize signal timing based on real-time traffic data with associated reliability indicators.

In block 820, Edge Node X completes training using a local data set. This completion phase involves finalizing the neural network training process using the locally collected data, resulting in a trained model with computed covariance matrix values for each layer that reflect the specific characteristics and statistical relationships present in the edge node's operational environment. The training completion may be determined by various criteria such as convergence of model parameters and their associated covariance matrices, achievement of target accuracy levels with confidence bounds, completion of predetermined training epochs with statistical validation, or satisfaction of performance thresholds including uncertainty measures. The locally trained model incorporates knowledge specific to the edge node's environment and use case, with layer-specific covariance matrices that capture the statistical relationships and confidence levels unique to local conditions, data distributions, and operational requirements. For example, in a manufacturing facility, Edge Node X might complete training of a quality control model that has learned to identify defects specific to the local production line's characteristics, with covariance matrix values for each layer that encode the statistical confidence and correlations between different sensor inputs and defect detection outcomes.

In block 825, Edge Node X stores the newly trained Application LLM/SLM, which includes covariance matrix values for each layer. This storage operation involves saving the completed model parameters, weights, configuration data, and the computed covariance matrix values for each neural network layer in local storage systems for future use and potential sharing with other nodes in the federated learning network. The storage process may include model serialization with covariance matrix preservation, compression techniques that maintain statistical integrity, and metadata generation that documents the confidence measures and statistical relationships captured in each layer's covariance matrix. The stored model represents the edge node's contribution to the federated learning process and contains both the learned knowledge from local training data and the statistical confidence information encoded in the layer-specific covariance matrices. The storage system may implement versioning capabilities to track different iterations of the model and its associated covariance matrices, enabling rollback operations and historical analysis of confidence evolution if needed. For example, in a healthcare monitoring system, Edge Node X might store a patient monitoring model that has been trained on local patient data, with covariance matrix values for each layer that capture the statistical relationships between different vital signs and diagnostic outcomes, ensuring that both the model parameters and confidence measures are preserved for continuous monitoring operations and potential contribution to a global healthcare model.

In block 830, a Control Node queries Edge Nodes for updates regarding the Application LLM/SLM covariance matrix values. This querying process involves the central control node initiating communication with multiple edge nodes to request information about their locally computed covariance matrix values for each layer of their trained models and any updates that may be available for statistical aggregation. The control node may implement various communication protocols and scheduling mechanisms to efficiently collect covariance matrix updates from distributed edge nodes without overwhelming the network or individual nodes, while ensuring the statistical integrity of the confidence measures is maintained during transmission. The query process may include requests for layer-specific covariance matrix parameters, statistical confidence metrics, correlation coefficients, or metadata that helps the control node evaluate the quality and statistical significance of each edge node's contribution to the global model's uncertainty quantification. For example, in a distributed environmental monitoring network, the Control Node might query edge nodes deployed across different geographic locations to collect covariance matrix updates from air quality prediction models that have been trained on local environmental data, requesting the statistical confidence measures and correlation matrices that capture the relationships between different environmental factors and prediction accuracy.

In block 835, the Edge Nodes send new Application LLM/SLM covariance matrix values for each layer to the Control Node. This transmission process involves packaging and securely transferring the computed covariance matrix data for each neural network layer from multiple edge nodes to the central control node for statistical aggregation and global confidence model creation. The edge nodes may implement various data compression techniques that preserve statistical accuracy, encryption methods that protect confidence information, and error correction protocols to ensure efficient and secure transmission of covariance matrix parameters over potentially unreliable network connections. The transmission may include not only the layer-specific covariance matrix values but also associated statistical metadata such as confidence intervals, correlation coefficients, sample sizes, and quality indicators that help the control node evaluate the statistical significance and reliability of each contribution. For example, in an autonomous vehicle network, edge nodes from different vehicles might send their locally computed covariance matrix values for each layer of their driving behavior models to the Control Node, including statistical information about the confidence levels associated with different driving conditions, road types, and weather patterns encountered during local training.

In block 840, the Control Node commences training of Application LLM/SLM using a NN Training Container. This centralized training initiation involves the control node beginning the process of aggregating and refining the received covariance matrix values from multiple edge nodes to create an improved global model with enhanced statistical confidence measures for each layer. The NN Training Container at the control node may implement federated learning algorithms such as statistical federated averaging, confidence-weighted federated optimization, or other aggregation techniques that combine the covariance matrix information from distributed edge nodes while maintaining statistical validity and data privacy. The training process may involve complex mathematical operations to merge layer-specific covariance matrices, resolve statistical conflicts between different node contributions, and optimize the global model's performance while preserving confidence measures and uncertainty quantification. For example, in a smart grid management system, the Control Node might commence training to aggregate covariance matrix values from energy consumption prediction models from multiple edge nodes representing different neighborhoods, using statistical federated learning techniques to create a comprehensive grid-wide prediction model with layer-specific confidence measures and uncertainty bounds.

In block 845, the Control Node completes training using Edge Node(s) training data. This completion phase involves finalizing the statistical aggregation and optimization process to produce an updated global model with consolidated covariance matrix values for each layer that incorporates the collective statistical knowledge from all participating edge nodes. The completion criteria may include convergence of the covariance matrix aggregation algorithms, achievement of target statistical confidence levels, satisfaction of predefined quality thresholds for uncertainty measures, or stabilization of layer-specific correlation patterns that ensure the global model meets the required statistical standards. The completed global model represents a synthesis of both learned knowledge and statistical confidence information from multiple edge nodes, with layer-specific covariance matrices that may offer improved accuracy, enhanced uncertainty quantification, and better statistical robustness compared to individual local models. For example, in a fraud detection system for financial services, the Control Node might complete training of a global fraud detection model that combines both pattern recognition capabilities and statistical confidence measures learned from edge nodes at different bank branches, resulting in a more comprehensive model with layer-specific covariance matrices capable of detecting diverse fraud patterns while providing confidence estimates across the entire network.

In block 850, the Control Node updates the appropriate Application LLM/SLM Model, including covariance matrix values for each layer, and makes it available for Edge Nodes to use. This distribution preparation process involves finalizing the global model with its associated layer-specific covariance matrices, performing statistical quality assurance checks on confidence measures, and preparing the updated model with its statistical components for deployment back to the edge nodes. The control node may implement model optimization techniques such as covariance matrix compression, statistical pruning that preserves confidence information, or quantization methods that maintain uncertainty measures to ensure the updated model with its statistical components is suitable for deployment on resource-constrained edge devices. The availability process may include updating model repositories with covariance matrix storage, generating deployment packages that include statistical metadata, and creating distribution mechanisms that enable edge nodes to efficiently retrieve and deploy both the updated model and its associated confidence measures. For example, in a retail inventory management system, the Control Node might update a demand forecasting model that incorporates sales patterns and statistical confidence measures from multiple store locations, making both the predictive model and its layer-specific covariance matrices available for deployment to all participating retail edge nodes.

In block 855, the Edge Nodes update their Application LLM/SLM. This final update process involves the edge nodes retrieving the improved global model with its associated covariance matrix values for each layer from the control node and deploying it locally to replace or enhance their existing models and statistical confidence measures. The update process may include model validation with statistical verification, compatibility checking for covariance matrix formats, and gradual deployment strategies that ensure smooth transition from the old model and its confidence measures to the new one without disrupting ongoing operations or statistical tracking. The edge nodes may implement rollback mechanisms in case the updated model or its associated covariance matrices do not perform as expected in the local environment, allowing restoration of previous statistical confidence levels. The updated model with its layer-specific covariance matrices enables the edge nodes to benefit from the collective learning and statistical knowledge of the entire federated network while maintaining their ability to perform local inference with confidence estimates and statistical decision-making. For example, in a predictive maintenance system for industrial equipment, edge nodes might update their equipment failure prediction models with the globally trained model that incorporates both failure patterns and statistical confidence measures learned from similar equipment across multiple industrial facilities, potentially improving their ability to predict and prevent equipment failures while providing uncertainty estimates and confidence intervals for maintenance scheduling decisions.

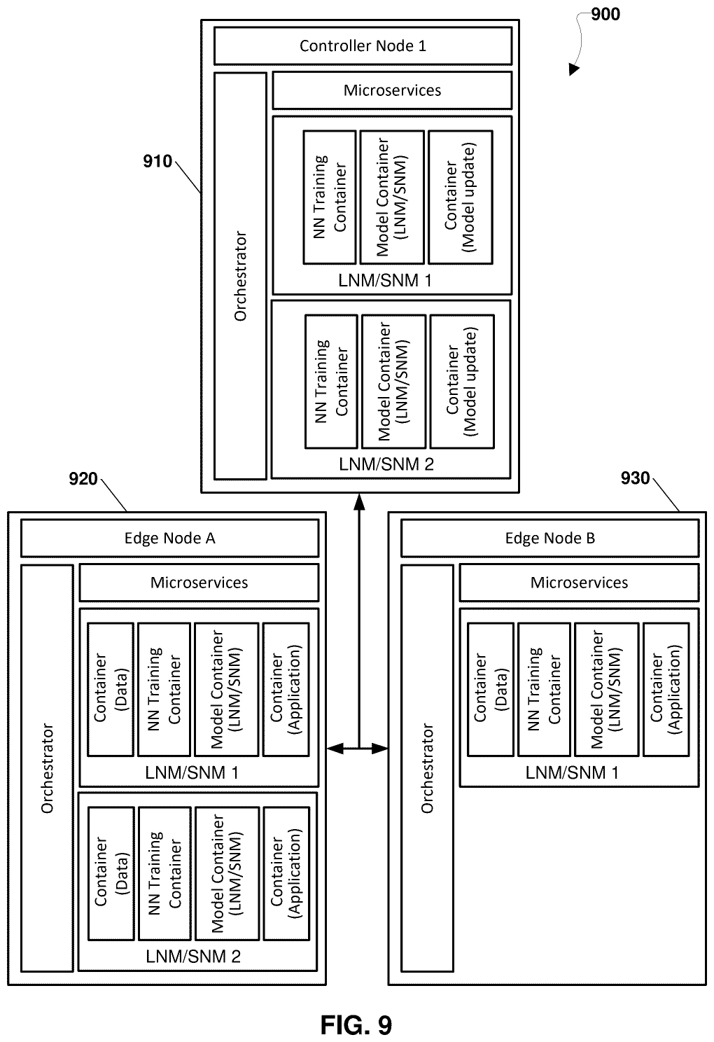

FIG. 9 is similar to FIG. 6, but the processing system is further configured to run multiple LLMs or SLMs in parallel on either the controller node 910 or the edge node(s) 920, 930. This parallel processing capability is illustrated in FIG. 9, in which the simultaneous operation of several models allows for more complex and diverse task management within the network.

In FIG. 9, the controller node hosts two distinct LLM/SLMs, each operating as a microservice. Edge Node A 920 also runs two different LLM/SLMs, corresponding to the microservices on the controller node. Each microservice at Edge Node A 920 processes a unique data set; however, these data sets may also be shared and sourced from the same sensors. The different LLM/SLMs may use the data, whether shared or unique, to generate inference outputs. These outputs may then be implemented in various applications, such as turning a device on, activating a device, issuing a text question, or performing other functions. In FIG. 9 the use of containers can enable multiple instances of the same LLM/SLM being used for different applications that use the same basic LLM/SLM and therefore allow them to become more tailored to a specific application or microservice as more data and training occurs. This also allows for a more efficient use of edge computing resources since the updates to the LLM/SLM are for a specific microservice/application and not several different applications. This also facilitates the use of a hybrid elastic edge computing network where edge nodes can have different computing capability and functions, which may need or not need constant refinement of the LLM/SLM.

The architecture shown in FIG. 9 can be further enhanced to incorporate blockchain technology for secure model distribution and management. In this enhanced implementation, when Edge Node A 920 completes training of its LLM/SLM models using local data, it can store these models along with their covariance matrix values for each neural network layer. The controller node can then query Edge Node A 920 and other edge nodes for updates regarding their trained models and associated covariance matrix values. Upon receiving these updates, the controller node can commence training to aggregate the model updates from multiple edge nodes, creating an improved global model that incorporates the collective knowledge from the distributed network. After completing this aggregation process, the controller node can store the updated global model with its covariance matrix values on a blockchain or Inter Planetary File System (IPFS), providing secure and immutable storage. The controller node can then update smart contracts to indicate the location of these updated models, allowing edge nodes to query the smart contracts to determine if new models are available. Edge nodes can obtain the location information from the smart contracts and retrieve the updated models from the blockchain or IPFS, completing the secure model distribution cycle while maintaining data privacy and integrity throughout the process.

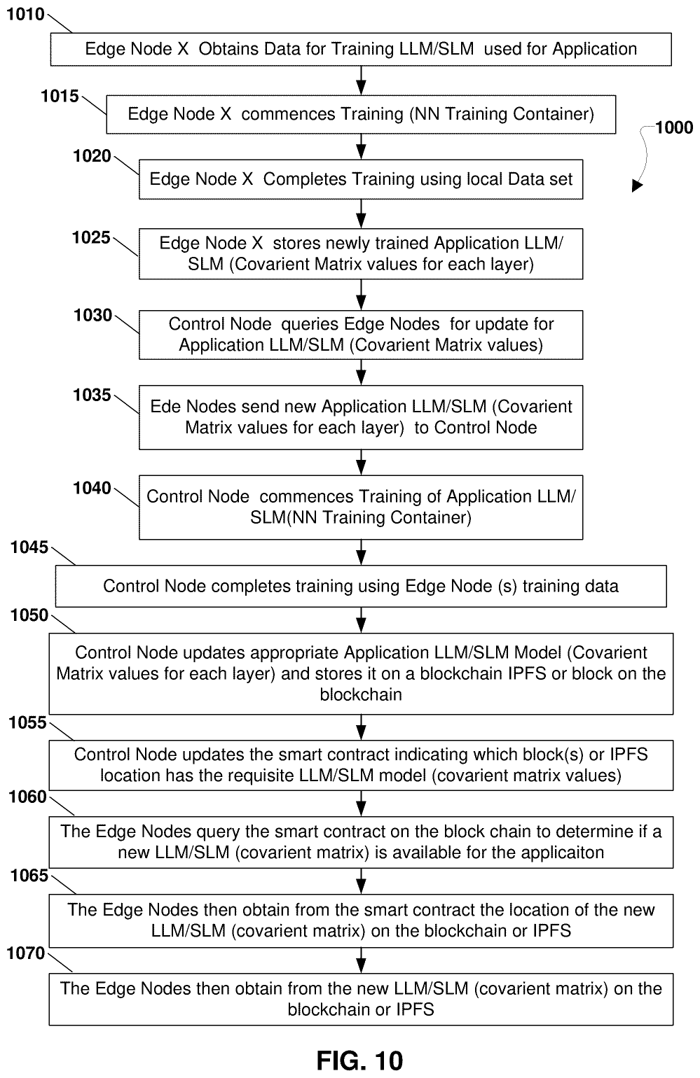

FIG. 10 illustrates method 1000, which comprises a comprehensive federated learning process that incorporates blockchain technology for secure model distribution and management. The method 1000 begins with edge node data collection and proceeds through local training, covariance matrix storage, centralized aggregation, blockchain-based model storage, smart contract updates, and finally edge node retrieval of updated models from the blockchain infrastructure.

In block 1010, Edge Node X obtains data for training LLM/SLM used for application. This data acquisition process involves collecting relevant information from local sources, sensors, or connected devices that will be used to train the machine learning model for a specific application within the blockchain-enabled federated learning environment. The edge node may gather various types of data depending on the application requirements, such as sensor readings with associated timestamps, user interactions with quality metrics, environmental measurements with accuracy indicators, or operational parameters with reliability assessments. The data collection process may be continuous or triggered by specific events, and the edge node may apply initial filtering or preprocessing to ensure data quality and establish baseline metrics for subsequent model training operations. For example, in an industrial monitoring application, Edge Node X might collect vibration data from machinery with sensor calibration information, temperature readings from equipment sensors with measurement precision data, and operational status information from control systems with reliability scores to train a predictive maintenance model that will later be integrated into the blockchain-based federated learning system.

In block 1015, Edge Node X commences training using a NN Training Container. This training initiation process involves starting the neural network training operations within a containerized environment that incorporates advanced statistical analysis and covariance matrix calculations for each layer of the neural network. The NN Training Container encapsulates all the necessary components for model training, including the training algorithms, optimization functions, covariance matrix computation modules, statistical analysis tools, and computational resources required for the learning process with confidence tracking and uncertainty quantification. The containerized approach ensures consistent training environments and enables efficient resource management across different edge nodes while maintaining layer-specific statistical measures that will be used in the blockchain-based model distribution system. The training process may utilize various machine learning techniques such as supervised learning with confidence weighting, unsupervised learning with uncertainty quantification, or reinforcement learning with action confidence measures depending on the application requirements and available data quality metrics. For example, in a smart city traffic management system, the NN Training Container might implement deep learning algorithms that calculate statistical measures for each neural network layer to analyze traffic flow patterns with confidence estimates and optimize signal timing based on real-time traffic data with associated reliability indicators.

In block 1020, Edge Node X completes training using local data set. This completion phase involves finalizing the neural network training process using the locally collected data, resulting in a trained model with computed statistical measures and covariance matrix values for each layer that reflect the specific characteristics and relationships present in the edge node's operational environment. The training completion may be determined by various criteria such as convergence of model parameters and their associated statistical measures, achievement of target accuracy levels with confidence bounds, completion of predetermined training epochs with statistical validation, or satisfaction of performance thresholds including uncertainty measures and quality metrics. The locally trained model incorporates knowledge specific to the edge node's environment and use case, with layer-specific statistical information that captures the relationships and confidence levels unique to local conditions, data distributions, and operational requirements. The completion process also involves validating the statistical integrity of the computed measures and ensuring that the model is ready for integration into the blockchain-based federated learning system. For example, in a manufacturing facility, Edge Node X might complete training of a quality control model that has learned to identify defects specific to the local production line's characteristics, with statistical measures for each layer that encode the confidence levels and correlations between different sensor inputs and defect detection outcomes.

In block 1025, Edge Node X stores the newly trained Application LLM/SLM, including covariance matrix values for each layer. This storage operation involves saving the completed model parameters, weights, configuration data, and the computed covariance matrix values for each neural network layer in local storage systems for future use and potential sharing with other nodes in the blockchain-enabled federated learning network. The storage process may include model serialization with statistical measure preservation, compression techniques that maintain the integrity of covariance matrix data, and metadata generation that documents the confidence measures and statistical relationships captured in each layer's covariance matrix. The stored model represents the edge node's contribution to the federated learning process and contains both the learned knowledge from local training data and the statistical confidence information encoded in the layer-specific covariance matrices that will be used for blockchain-based model aggregation. The storage system may implement versioning capabilities to track different iterations of the model and its associated statistical measures, enabling rollback operations and historical analysis of confidence evolution if needed. For example, in a healthcare monitoring system, Edge Node X might store a patient monitoring model that has been trained on local patient data, with covariance matrix values for each layer that capture the statistical relationships between different vital signs and diagnostic outcomes, ensuring that both the model parameters and confidence measures are preserved for continuous monitoring operations and potential contribution to the blockchain-based global healthcare model.

In block 1030, Control Node queries Edge Nodes for updates regarding the Application LLM/SLM covariance matrix values. This querying process involves the central control node initiating communication with multiple edge nodes to request information about their locally computed covariance matrix values for each layer of their trained models and any updates that may be available for statistical aggregation and subsequent blockchain storage. The control node may implement various communication protocols and scheduling mechanisms to efficiently collect covariance matrix updates from distributed edge nodes without overwhelming the network or individual nodes, while ensuring the statistical integrity of the confidence measures is maintained during transmission and preparation for blockchain integration. The query process may include requests for layer-specific covariance matrix parameters, statistical confidence metrics, correlation coefficients, model version information, or metadata that helps the control node evaluate the quality and statistical significance of each edge node's contribution to the global model's uncertainty quantification before blockchain storage. For example, in a distributed environmental monitoring network, the Control Node might query edge nodes deployed across different geographic locations to collect covariance matrix updates from air quality prediction models that have been trained on local environmental data, requesting the statistical confidence measures and correlation matrices that capture the relationships between different environmental factors and prediction accuracy for subsequent blockchain-based model distribution.

In block 1035, Edge Nodes send new Application LLM/SLM covariance matrix values for each layer to the Control Node. This transmission process involves packaging and securely transferring the computed covariance matrix data for each neural network layer from multiple edge nodes to the central control node for statistical aggregation and preparation for blockchain-based global model creation and distribution. The edge nodes may implement various data compression techniques that preserve statistical accuracy, encryption methods that protect confidence information, and error correction protocols to ensure efficient and secure transmission of covariance matrix parameters over potentially unreliable network connections before the data is processed for blockchain storage. The transmission may include not only the layer-specific covariance matrix values but also associated statistical metadata such as confidence intervals, correlation coefficients, sample sizes, model versioning information, and quality indicators that help the control node evaluate the statistical significance and reliability of each contribution before blockchain integration. For example, in an autonomous vehicle network, edge nodes from different vehicles might send their locally computed covariance matrix values for each layer of their driving behavior models to the Control Node, including statistical information about the confidence levels associated with different driving conditions, road types, and weather patterns encountered during local training, preparing this data for secure blockchain-based model distribution across the vehicle network.

In block 1040, Control Node commences training of Application LLM/SLM using a NN Training Container. This centralized training initiation involves the control node beginning the process of aggregating and refining the received covariance matrix values from multiple edge nodes to create an improved global model with enhanced statistical confidence measures for each layer that will be stored and distributed through the blockchain infrastructure. The NN Training Container at the control node may implement federated learning algorithms such as statistical federated averaging, confidence-weighted federated optimization, or other aggregation techniques that combine the covariance matrix information from distributed edge nodes while maintaining statistical validity, data privacy, and preparing the aggregated model for blockchain-based distribution. The training process may involve complex mathematical operations to merge layer-specific covariance matrices, resolve statistical conflicts between different node contributions, optimize the global model's performance while preserving confidence measures and uncertainty quantification, and format the resulting model for efficient blockchain storage and retrieval. For example, in a smart grid management system, the Control Node might commence training to aggregate covariance matrix values from energy consumption prediction models from multiple edge nodes representing different neighborhoods, using statistical federated learning techniques to create a comprehensive grid-wide prediction model with layer-specific confidence measures and uncertainty bounds that will be stored on the blockchain for secure distribution to all participating nodes.

In block 1045, Control Node completes training using Edge Node(s) training data. This completion phase involves finalizing the statistical aggregation and optimization process to produce an updated global model with consolidated covariance matrix values for each layer that incorporates the collective statistical knowledge from all participating edge nodes and is ready for blockchain storage and distribution. The completion criteria may include convergence of the covariance matrix aggregation algorithms, achievement of target statistical confidence levels, satisfaction of predefined quality thresholds for uncertainty measures, stabilization of layer-specific correlation patterns that ensure the global model meets the required statistical standards, and verification that the model format is compatible with blockchain storage requirements. The completed global model represents a synthesis of both learned knowledge and statistical confidence information from multiple edge nodes, with layer-specific covariance matrices that may offer improved accuracy, enhanced uncertainty quantification, and better statistical robustness compared to individual local models, while being optimized for efficient blockchain-based distribution. For example, in a fraud detection system for financial services, the Control Node might complete training of a global fraud detection model that combines both pattern recognition capabilities and statistical confidence measures learned from edge nodes at different bank branches, resulting in a more comprehensive model with layer-specific covariance matrices capable of detecting diverse fraud patterns while providing confidence estimates across the entire network, formatted for secure blockchain storage and distribution.

In block 1050, Control Node updates the appropriate Application LLM/SLM Model with covariance matrix values for each layer and stores it on a blockchain IPFS or block on the blockchain. This storage operation involves finalizing the global model with its associated layer-specific covariance matrices, performing final quality assurance checks on confidence measures, and securely storing the updated model with its statistical components on either the blockchain directly or through the Inter Planetary File System (IPFS) for distributed access by edge nodes. The control node may implement model optimization techniques such as covariance matrix compression for blockchain efficiency, statistical pruning that preserves confidence information while reducing storage requirements, or quantization methods that maintain uncertainty measures while optimizing for blockchain storage constraints. The storage process may include generating cryptographic hashes for model integrity verification, creating blockchain transactions that record model metadata, and establishing IPFS links that enable efficient distributed retrieval of large model files while maintaining the security and immutability provided by blockchain technology. For example, in a retail inventory management system, the Control Node might store a demand forecasting model that incorporates sales patterns and statistical confidence measures from multiple store locations on the blockchain, with the actual model parameters stored in IPFS and referenced through blockchain entries, making both the predictive model and its layer-specific covariance matrices available for secure and efficient distribution to all participating retail edge nodes.

In block 1055, Control Node updates the smart contract indicating which blocks or IPFS location has the requisite LLM/SLM model covariance matrix values. This smart contract update process involves modifying the blockchain-based smart contract to include current information about the location and availability of the updated model with its associated covariance matrix values, enabling edge nodes to automatically discover and retrieve the latest model versions. The control node may update smart contract parameters that specify blockchain block numbers containing model metadata, IPFS hash addresses where model files are stored, version numbers for tracking model evolution, and access permissions that control which edge nodes can retrieve specific model components. The smart contract update may also include conditional logic that determines model distribution based on edge node capabilities, application requirements, or network conditions, ensuring that each edge node receives the most appropriate model version for its specific use case. For example, in a distributed manufacturing network, the Control Node might update smart contracts to indicate that the latest quality control model with covariance matrix values is stored in IPFS with a specific hash address, while the model metadata and access permissions are recorded in blockchain block 1055, allowing manufacturing edge nodes to automatically query the smart contract and retrieve the updated model when needed for their local quality control operations.

In block 1060, Edge Nodes query the smart contract on the blockchain to determine if a new LLM/SLM covariance matrix is available for the application. This querying process involves edge nodes periodically or event-driven checking of the blockchain-based smart contract to discover whether updated models with enhanced covariance matrix values are available for their specific applications or use cases. The edge nodes may implement various querying strategies such as periodic polling at predetermined intervals, event-driven queries triggered by local performance degradation, or notification-based systems where smart contracts actively inform edge nodes about model updates. The query process may include checking model version numbers against locally stored versions, evaluating compatibility requirements between new models and local hardware capabilities, and assessing whether the updated model's statistical improvements justify the resources required for downloading and deployment. For example, in a smart agriculture network, edge nodes monitoring crop conditions might query smart contracts daily to check for updated plant disease detection models with improved covariance matrix values, comparing the available model versions against their currently deployed models to determine if the enhanced statistical confidence measures and improved accuracy warrant updating their local disease detection capabilities.

In block 1065, Edge Nodes obtain from the smart contract the location of the new LLM/SLM covariance matrix on the blockchain or IPFS. This location retrieval process involves edge nodes extracting specific addressing information from the smart contract that indicates where the updated model with its covariance matrix values can be accessed, whether stored directly on the blockchain or through IPFS distributed storage. The edge nodes may parse smart contract data to obtain blockchain block numbers containing model components, IPFS hash addresses for large model files, access credentials or permissions required for model retrieval, and metadata that describes the model's capabilities and requirements. The location information may also include alternative storage locations for redundancy, checksums for verifying model integrity during download, and compatibility indicators that help edge nodes determine if the model is suitable for their specific hardware and application requirements. For example, in a traffic management system, edge nodes at different intersections might obtain from smart contracts the IPFS addresses where updated traffic prediction models with enhanced covariance matrices are stored, along with blockchain references containing model metadata and performance benchmarks that help each edge node evaluate whether the updated model will improve its local traffic optimization capabilities.

In block 1070, Edge Nodes obtain the new LLM/SLM covariance matrix from the blockchain or IPFS. This final retrieval process involves edge nodes downloading and deploying the updated model with its associated covariance matrix values from the specified blockchain or IPFS locations, completing the blockchain-enabled federated learning cycle. The edge nodes may implement secure download protocols that verify model integrity through cryptographic hash checking, validate model compatibility with local hardware and software environments, and perform gradual deployment strategies that ensure smooth transition from old models to new ones without disrupting ongoing operations. The retrieval process may also include backup and rollback mechanisms in case the updated model does not perform as expected in the local environment, allowing edge nodes to restore previous model versions while reporting performance issues back to the control node through the blockchain infrastructure. For example, in a predictive maintenance system for industrial equipment, edge nodes might download updated equipment failure prediction models with enhanced covariance matrices from IPFS, verify the model integrity using blockchain-stored checksums, and gradually deploy the new models while monitoring their performance against historical baselines, potentially improving their ability to predict and prevent equipment failures while providing enhanced uncertainty estimates and confidence intervals for maintenance scheduling decisions.

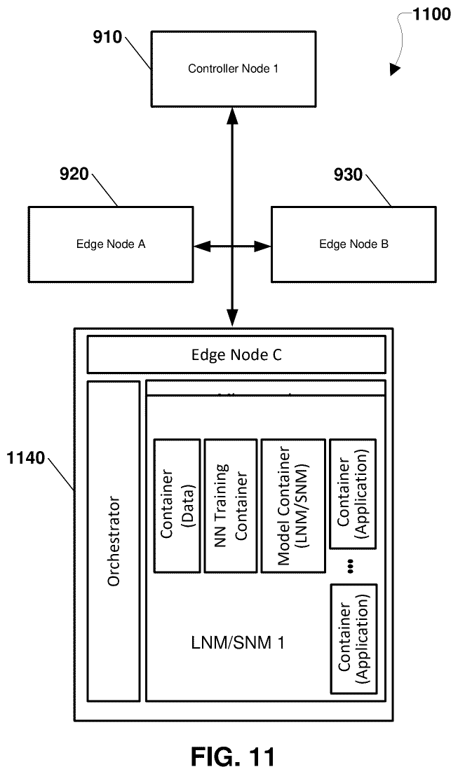

FIG. 11 illustrates a four-node Federated Learning (FL) network system 1100 with Artificial Intelligence (AI), building upon the architecture shown in FIG. 9 by introducing an additional edge node, Edge Node C 1140. This expanded network demonstrates the scalability and flexibility of the FLwBC-AI system. Edge Node C 1140 showcases a more complex implementation of the Predictive Holistic Inference Logic (PHIL) concept, where multiple applications utilize the output of the Large Language Model (LLM) or Smaller Learning Model (SLM) as input.

The PHIL cascaded LLM/SLM approach implemented in Edge Node C 1140 exemplifies how the system can handle scenarios requiring several distinct functions with varying model requirements. This architecture optimizes performance by allowing each LLM/SLM to be finely tuned for a specific role, while still enabling the integration of multiple models to achieve an optimal solution.

For instance, one LLM/SLM model could be dedicated to determining the most suitable service application to utilize based on current network conditions and user requirements. Once this selection is made, a second LLM/SLM focused on routing or network topology could be employed to identify the optimal network path or components needed to deliver the selected service efficiently.

Another powerful application of the PHIL cascaded LLM/SLM approach is in network resilience and fault tolerance. While the overall objective of the application being delivered remains constant, the system can dynamically adapt to failures or degradations in network components. In such scenarios, a specialized LLM/SLM tailored for the specific network element experiencing issues can be activated. This model, having been trained on the particular characteristics and failure modes of that component, can rapidly generate the most efficient and timely response to maintain optimal service delivery.

This sophisticated use of multiple, specialized LLM/SLM models within the PHIL framework enables the FLwBC-AI system to handle complex, multi-faceted network management tasks with greater efficiency and adaptability than traditional approaches. By leveraging the strengths of different models in a cascaded manner, the system can make nuanced decisions that consider various aspects of network performance, service quality, and resource utilization simultaneously.

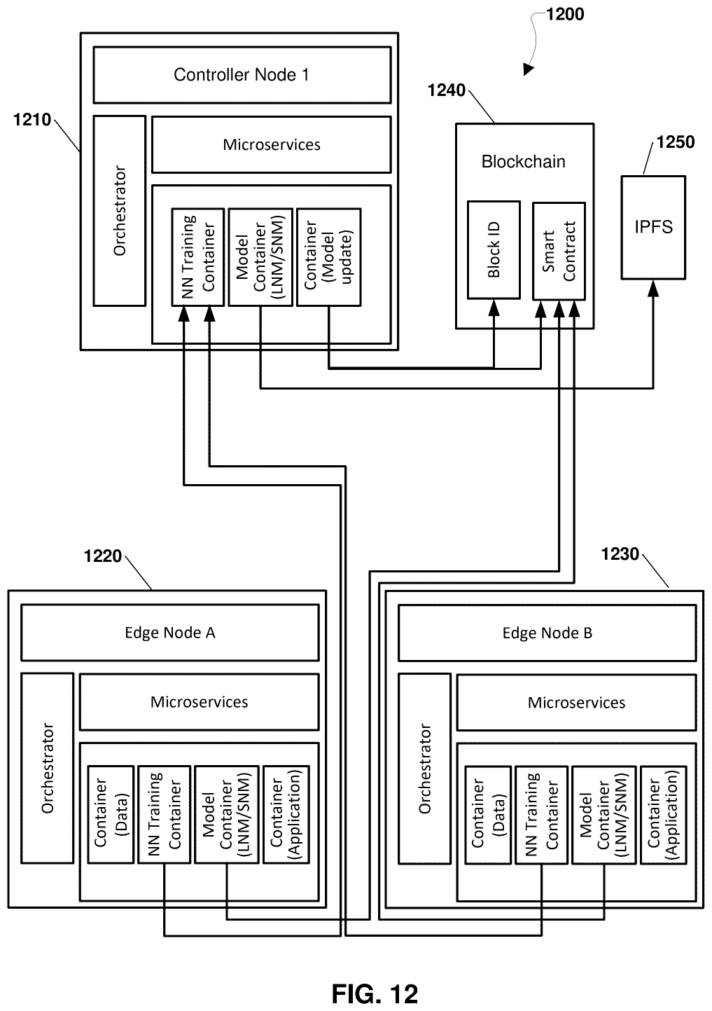

The FLwBC-AI topology illustrated in FIG. 12 demonstrates a compact three-node system that effectively showcases the core concepts of the federated learning with blockchain and artificial intelligence architecture. By leveraging blockchain's inherent features, the system ensures that model updates maintain crucial properties of immutability, security, and traceability through proof-of-work mechanisms. This approach significantly enhances the reliability and trustworthiness of the federated learning process.

The FLwBC-AI system operates as a distributed network primarily driven by two key actors: trainers and validators. Trainers, typically represented by edge nodes, are responsible for local model training and updates, while validators ensure the integrity and consensus of the blockchain network. In the configuration shown, Controller Node 1 serves a dual role by communicating with the blockchain using smart contracts and functioning as a validator. However, the system's flexibility allows for the deployment of separate blockchain validators if needed, which can further enhance the decentralization and security of the network.

A key advantage of the FLwBC-AI system is its ability to optimize communication overhead. This is achieved by maintaining a fixed number of active parameters during both the training process and peer-to-peer communication among nodes. Such optimization is crucial in edge computing environments where bandwidth and computational resources may be constrained.

The system's architecture, as depicted in FIG. 12, showcases a sophisticated approach to model management and distribution. Updated Large Language Models (LLMs) or Smaller Learning Models (SLMs), which may include Covariance Matrix values, can be stored either in an Inter Planetary File System (IPFS) for distributed and efficient access, or directly on blockchain blocks for enhanced security and immutability. The Model Update container facilitates the process of placing updated model weights on the blockchain, ensuring a transparent and verifiable update mechanism.

Smart contracts play a pivotal role in this architecture, serving as intelligent intermediaries that manage model updates and distribution. When updated with the Model Update container, a smart contract can indicate the availability of new model updates to relevant edge nodes, specifically tailored to the attributes of particular LLM/SLM configurations. This targeted distribution ensures that edge nodes receive only the updates pertinent to their specific models and applications.

The versatility of smart contracts in this system extends to their ability to either store updated weights directly or reference specific blockchain blocks containing the required LLM/SLM data. Furthermore, smart contracts can provide instructions to edge node containers regarding the location of LLM/SLM images or files within the IPFS system. This capability includes access to past versions of models, which is particularly valuable in heterogeneous edge computing environments where different sensors or edge devices may require specific model versions for optimal performance.

The inclusion of version management in the smart contract functionality addresses the challenges posed by the diverse nature of edge computing ecosystems. It allows for the coexistence of multiple model versions, catering to the varied requirements of different edge nodes and applications. This feature is especially crucial in scenarios where edge devices have disparate capabilities or when applications demand specific model iterations for optimal performance.

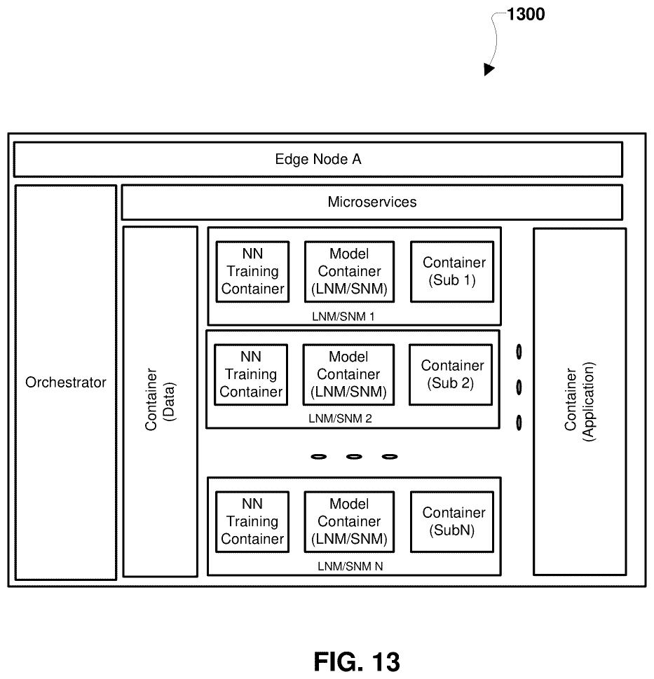

FIG. 13 illustrates an edge node utilizing multiple Large Language Models (LLMs) or Smaller Learning Models (SLMs), each operating as a separate microservice. These individual microservices feed into another microservice, referred to as an Application container. In FIG. 13, all outputs from the various microservices serve as inputs to a single application. However, in other scenarios, these microservices could provide inputs to multiple applications.

The Predictive Holistic Inference Logic (PHIL) approach, as depicted in FIG. 7, is employed when an application requires multiple inputs from distinct LLM/SLMs. This approach can be particularly beneficial in complex manufacturing processes or similar functions that involve multiple interconnected steps or parameters.

To illustrate the PHIL concept, consider a manufacturing scenario involving two distinct processes, each optimized by its own LLM/SLM. The first LLM/SLM is trained to provide the optimum flow of material into one machine, while the second LLM/SLM is tailored to optimize the flow into another machine or subsequent process. Although these processes are related, they may have sufficiently specific requirements to justify the use of unique LLM/SLMs for each.

By implementing PHIL, the outputs from these two uniquely trained LLM/SLMs are used as inputs into the application governing the overall process. This integration enables the system to derive an optimal solution that considers the nuances of each sub-process. The PHIL approach not only allows for the combination of specialized models but also facilitates dynamic adjustments based on new data received either from the input to the first machine or the output of one machine feeding into another machine's input process.

This dynamic adaptation capability of PHIL is crucial in real-world manufacturing environments where conditions can change rapidly. It allows the system to continuously refine its predictions and optimizations, ensuring that the manufacturing process remains efficient and responsive to varying conditions. By leveraging the strengths of multiple specialized models and combining their outputs intelligently, PHIL enables more sophisticated and adaptable control over complex, multi-stage processes than would be possible with a single, generalized model.

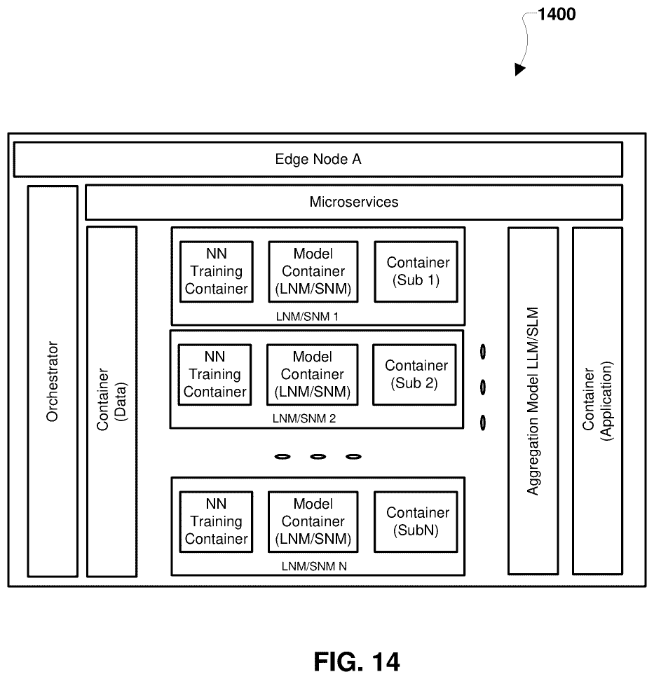

FIG. 14 expands upon the architecture presented in FIG. 13 by introducing an additional layer of processing. In this enhanced configuration, the outputs generated by various microservices are first processed through a Large Language Model (LLM) or Smaller Learning Model (SLM) and then further refined by an application. These processed outputs are subsequently utilized as inputs for another LLM/SLM, creating a cascading effect of model interactions. This approach allows for more sophisticated analysis and decision-making processes by leveraging the strengths of multiple specialized models.

The concept of Predictive Holistic Inference Logic (PHIL) is exemplified in FIG. 8, where the outputs from multiple LLM/SLMs (labeled as 1, 2, and N) serve as inputs for a final, aggregating LLM/SLM. This parallel processing technique, akin to LLM/SLM slicing, enables faster and more optimized inputs for the final model. Each contributing LLM/SLM is trained for a specific purpose, allowing for targeted analysis of different aspects of the input data.

A practical application of this multi-model approach could be in advanced surveillance systems. In such a scenario, various LLM/SLMs could be employed to analyze different aspects of the surveillance data:

1. One LLM/SLM might focus on biosensor data analysis, detecting anomalies in physiological indicators.

2. Another could specialize in weapon detection, identifying potential threats from visual or sensor data.

3. A third LLM/SLM could be dedicated to facial recognition, processing image data to identify individuals of interest.

The outputs from these specialized models would then feed into a final LLM/SLM. This aggregating model would be responsible for synthesizing the insights from all preceding models to produce a comprehensive threat analysis. Based on this holistic evaluation, the system could determine optimal actions or responses to potential security risks.

This multi-tiered approach allows for more nuanced and accurate threat assessment by combining the strengths of multiple specialized models. It exemplifies the power of federated learning with blockchain and artificial intelligence (FLwBC-AI) in creating sophisticated, adaptive systems capable of handling complex, multi-faceted analysis tasks in real-time edge computing environments.

Blockchains with smart contract technology may also manage software delivery and training of local or global models. This technology may deliver multiple LLM/SLM models to the ECN or edge device.

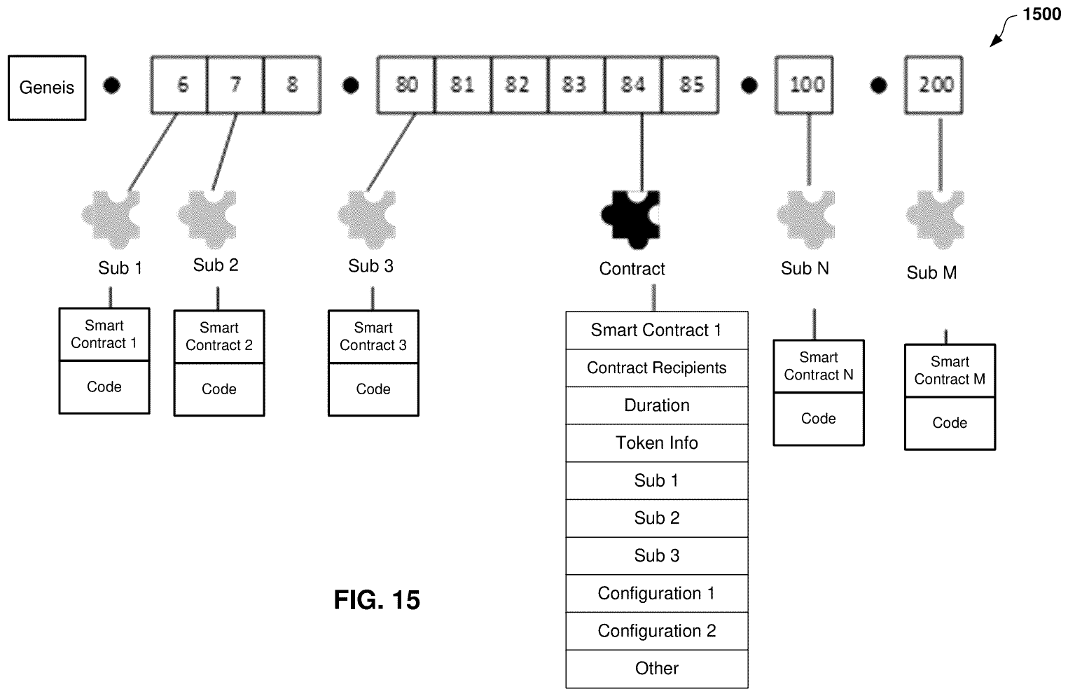

FIG. 15 illustrates a blockchain with smart contracts, showcasing how software, configuration data, and components for various elements including smart devices, nodes, and Large Language Models/Smaller Learning Models (LLM/SLMs) can be stored directly on the blockchain. This architecture allows for a modular and flexible approach to data and model management. The block numbers within the blockchain can be referenced in a smart contract, enabling devices to extract information from specific blocks in a predetermined sequence, analogous to assembling building blocks in a particular order.

This system offers significant advantages for federated learning and application deployment. For instance, an edge node can receive instructions from a smart contract indicating the need for multiple LLM/SLMs for a specific application. The blockchain-based smart contracts can be updated periodically to reflect evolving requirements for federated learning or newly developed applications. This update mechanism eliminates the need to modify every device individually, which is particularly beneficial for devices in power-saving dormant modes. Upon awakening, these devices can receive instructions pertaining to a new set of LLM/SLMs or application software, which may be in the form of container images.

The flexibility of this system extends to the storage options for these container images. They can be stored directly on the blockchain, in an Inter Planetary File System (IPFS), or in a dedicated container repository. This versatility allows for optimal storage and retrieval based on the specific needs of the application and the capabilities of the network.

The smart contract associated with a three-node network (e.g., network 900 in FIG. 9) demonstrates this concept, where LLM/SLM1 could be stored in block 6 and LLM/SLM2 in block 7. This arrangement enables the use of different smart contracts for various applications or microservices. For example, one application microservice might only require LLM/SLM1, while another may need both LLM/SLM1 and LLM/SLM2, or potentially even more models. This granular control over model distribution and usage allows for efficient resource allocation and tailored functionality across different edge computing scenarios.

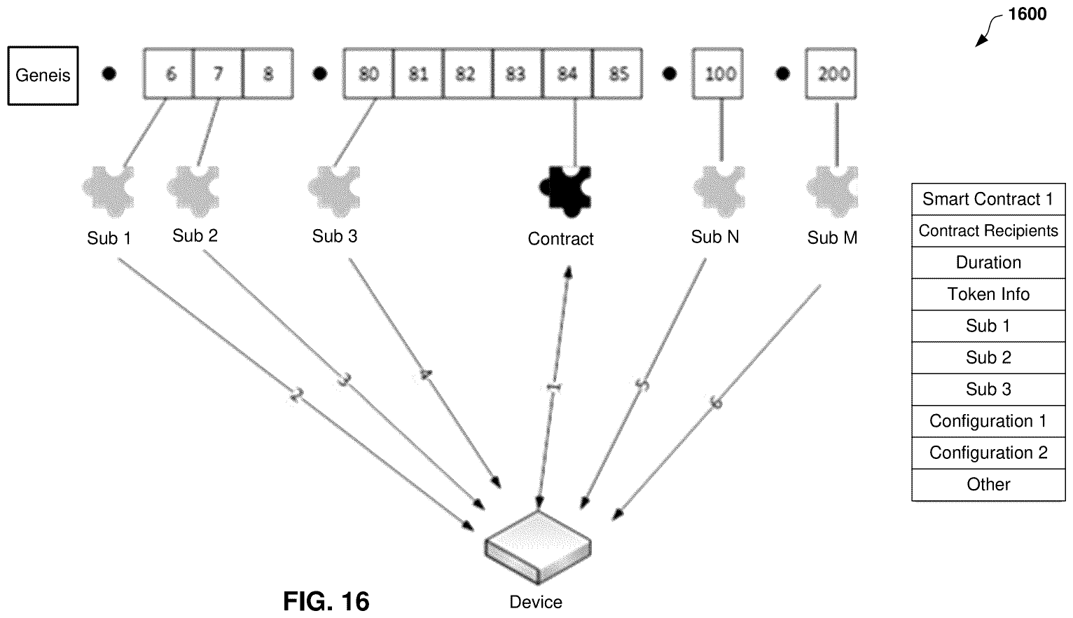

FIG. 16 illustrates a sophisticated process within the Federated Learning with Blockchain and Artificial Intelligence (FLwBC-AI) framework, where edge devices or Edge Computing Nodes (ECNs) interact with the blockchain through smart contracts. This interaction enables a decentralized and secure method for updating and distributing machine learning models. The smart contract serves as an intelligent intermediary, providing crucial information to the edge devices or ECNs about the location of updated weights for Large Language Models (LLMs) or Smaller Learning Models (SLMs). This location could be directly on the blockchain or in a distributed file system like the InterPlanetary File System (IPFS), which offers efficient storage and retrieval of large datasets. Additionally, the smart contract may outline specific tasks or operations that the edge device or ECN must execute, ensuring a coordinated and standardized approach across the network.

In some embodiments, operational methods executed on an ECN include receiving a blockchain block address from a smart contract that specifies the location of a covariance matrix relevant to the current task. The ECN then loads the specified covariance matrix into a shared neural network structure and processes local data through this configured neural network to produce task-specific outputs. This process is repeated sequentially for additional covariance matrices corresponding to second and optionally third tasks, wherein the output of earlier tasks can form part of the input for subsequent neural network executions.

The FLwBC-AI framework also supports a bidirectional flow of information. While FIG. 16 depicts the retrieval of model updates by edge devices, the system also allows for the reverse process. Edge devices or ECNs can contribute to the collective intelligence of the network by writing new weights or updated LLM/SLM models directly to the blockchain. This process is governed by smart contracts, which play a crucial role in maintaining the integrity and consistency of the federated learning system. These contracts provide detailed instructions to the ECNs or edge devices, specifying which LLM/SLM to utilize, where to locate the required model, and whether multiple models are necessary for a particular microservice. This dynamic and flexible approach allows the FLwBC-AI system to adapt to varying computational requirements and optimize resource allocation across the network, enhancing the overall efficiency and effectiveness of edge intelligence applications.

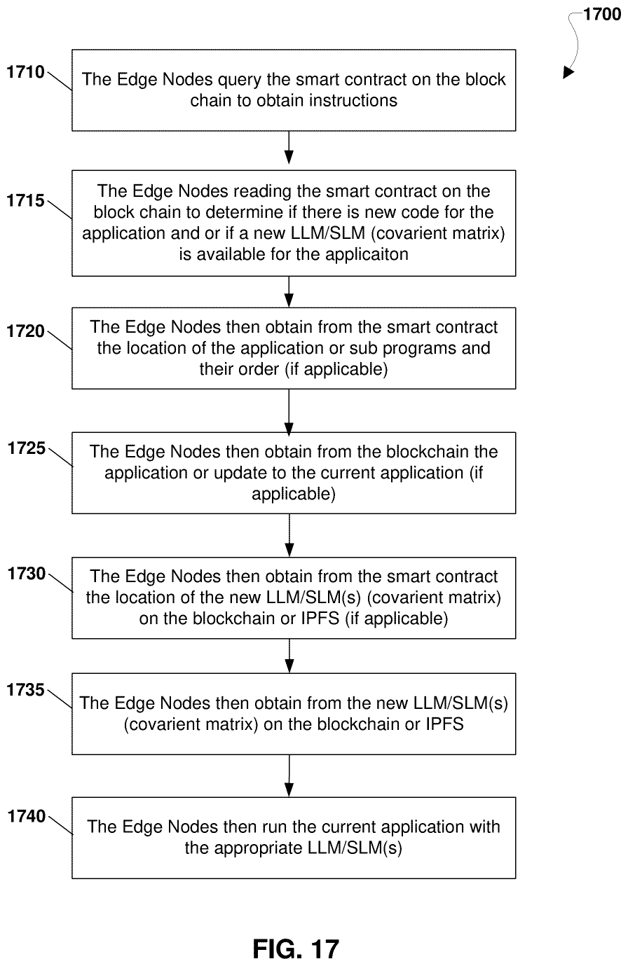

FIG. 17 illustrates method 1700, which comprises a comprehensive process for edge nodes to query and obtain instructions from smart contracts on a blockchain infrastructure. The method begins with edge nodes querying smart contracts to obtain operational instructions, followed by reading the smart contracts to determine if new application code and/or updated LLM/SLM models with covariance matrix values are available. The process continues with edge nodes obtaining location information for applications or sub-programs and their execution order from the smart contracts, then retrieving the actual applications or updates from the blockchain when applicable. Subsequently, the edge nodes obtain location information for new LLM/SLM models with covariance matrices from the smart contracts, retrieve these models from either the blockchain or IPFS storage systems, and finally execute the current application using the current LLM/SLM models.

The overall purpose of method 1700 is to enable automated and secure distribution of software applications and machine learning models to edge computing nodes through blockchain-based smart contracts. The method facilitates decentralized management of edge computing resources by allowing nodes to autonomously discover, retrieve, and deploy updated applications and AI models without requiring centralized coordination or manual intervention.

Examples of systems that may perform method 1700 include edge computing nodes equipped with blockchain connectivity such as industrial IoT gateways, autonomous vehicle computing units, smart city infrastructure nodes, manufacturing equipment controllers, and distributed sensor networks. These systems may incorporate processors, memory, storage, and communication interfaces necessary for blockchain interaction, smart contract execution, and local application deployment.

Examples of systems that may interact with the apparatus performing method 1700 include blockchain networks that host the smart contracts and store application metadata, IPFS distributed storage systems that maintain large application files and model data, smart contract development platforms that create and deploy the contracts governing application distribution, cloud-based repositories that serve as backup storage for applications and models, and monitoring systems that track the deployment status and performance of applications across the edge computing network.

The smart contract associated with the method 1700 in FIG. 17 could instruct the ECN to obtain microservice code from a blockchain block or an IPFS location. Smart contracts could also facilitate the use of multiple LLM/SLMs either in parallel or serially. The location of each LLM/SLM may be specified on the blockchain or an IPFS system, and the order in which they are applied may be defined by the smart contract in an FLwBC-AI implementation.

Moreover, the smart contract may define different weights for each layer of a neural network (NN). For instance, based on specific requirements, different weights might be needed for several deep learning layers compared to the general model. Smart contracts may also assist in pruning or expanding LLM/SLM models based on the desired and observed accuracy.

Another advantage of using smart contracts within the FLwBC-AI implementation is the ability to reuse resources on an edge device or ECN by swapping out an LLM/SLM for different functions as needed. For example, LLM/SLM (1) could be used to determine one optimal solution at a given time, and then the resources could be repurposed for LLM/SLM (2) to complete a second task. Depending on the type of LLM/SLM being changed, only a weight change may be required. The ability to reuse resources by changing the weights would enable a resource constrained device to be able to process more complex tasks. For instance a edge device could perform the necessary function to provide the inputs to application1. The LLM/SLM could be then be repurposed with weight changes so the LLM/SLM has a different function using the same resources on the edge computing device. Through using a dynamic LLM/SLM approach PHIL enables resource constrained devices to utilize the power of LLM/SLMs without having to have several LLM/SLMs or a larger LLM/SLM that can address multiple diverse applications. However, if more extensive modifications are necessary, a new model may be retrieved from the IPFS or a similar process.

FLwBC-AI may enable a wireless distribution system with automatic topology learning and wireless and wired path configuration. Currently, this involves manual intervention for tasks such as provisioning, network compute sharing, and self-healing. Key concepts to address when creating a reliable and versatile network design may include: always on and resilient (ensuring continuous availability); intelligent (adapting to changing needs beyond basic standards by leveraging insights into network activity); secure (protecting the organization and its users); and planning for the future (incorporating forward-looking strategies). FLwBC-AI may play a significant role in the intelligent adaptation of the network to allow for regular adjustments based on internal and external factors.

In block 1710, the Edge Nodes query the smart contract on the blockchain to obtain instructions. This querying process involves the edge nodes initiating communication with the blockchain infrastructure to retrieve operational directives and configuration information stored within smart contracts. The edge nodes may implement various communication protocols and authentication mechanisms to securely access the blockchain network and interact with the deployed smart contracts. The querying process may include sending requests that contain node identification information, current operational status, or specific application requirements to help the smart contract determine the appropriate instructions to provide. For example, an industrial IoT gateway might query a smart contract to obtain instructions about which predictive maintenance models to deploy, while a smart city traffic management node might query for instructions regarding traffic optimization algorithms and their deployment parameters.

In block 1715, the Edge Nodes read the smart contract on the blockchain to determine if there is new code for the application and/or if a new LLM/SLM (covariance matrix) is available for the application. This reading process involves parsing and interpreting the smart contract data to identify available updates, new application versions, or enhanced machine learning models that may improve the edge node's performance. The edge nodes may evaluate version numbers, compatibility requirements, and deployment conditions specified within the smart contract to determine the relevance and applicability of available updates. The reading process may also involve checking timestamps, digital signatures, and other metadata to verify the authenticity and currency of the available code or models. For example, an autonomous vehicle computing unit might read smart contract data to determine if updated navigation algorithms are available, while a manufacturing equipment controller might check for new quality control models that incorporate recent training data from other facilities.

In block 1720, the Edge Nodes obtain from the smart contract the location of the application or sub programs and their order (if applicable). This location retrieval process involves extracting specific addressing information and sequencing instructions from the smart contract that indicate where application components can be accessed and how they should be executed. The edge nodes may parse smart contract data to obtain blockchain block numbers, IPFS hash addresses, or other storage location identifiers that point to the required application files or sub-programs. The ordering information may specify execution sequences, dependency relationships, or priority levels that govern how multiple application components should be deployed and coordinated. For example, a distributed sensor network node might obtain location information for multiple data processing modules that must be executed in a specific sequence, while a smart building management system might retrieve locations for various optimization algorithms that need to be coordinated for energy management.

In block 1725, the Edge Nodes obtain from the blockchain the application or update to the current application (if applicable). This retrieval process involves downloading and deploying the actual application files, updates, or patches from the specified blockchain locations or associated storage systems. The edge nodes may implement secure download protocols that verify file integrity through cryptographic hash checking, validate digital signatures, and ensure compatibility with local hardware and software environments. The deployment process may include backup procedures for current applications, gradual rollout strategies to minimize service disruption, and rollback mechanisms in case the new application does not perform as expected. For example, a retail point-of-sale system might download updated inventory management software from the blockchain, while a healthcare monitoring device might retrieve enhanced patient data analysis applications that incorporate new diagnostic algorithms.

In block 1730, the Edge Nodes obtain from the smart contract the location of the new LLM/SLM(s) (covariance matrix) on the blockchain or IPFS (if applicable). This location acquisition process involves retrieving addressing information for machine learning models and their associated statistical components from smart contract data. The edge nodes may parse smart contract entries to obtain specific blockchain block references, IPFS content identifiers, or other distributed storage addresses where the updated models and covariance matrices are stored. The location information may also include access credentials, encryption keys, or permission tokens required to retrieve the models from secure storage systems. For example, a medical diagnostic edge device might obtain location information for updated disease detection models with enhanced statistical confidence measures, while a financial fraud detection system might retrieve addresses for improved transaction analysis models that incorporate recent threat intelligence.

In block 1735, the Edge Nodes obtain from the new LLM/SLM(s) (covariance matrix) on the blockchain or IPFS. This model retrieval process involves downloading and deploying the updated machine learning models and their associated covariance matrix values from the specified storage locations. The edge nodes may implement secure transfer protocols that ensure model integrity during download, validate model compatibility with local processing capabilities, and perform gradual deployment strategies that maintain service continuity. The retrieval process may also include verification of model performance benchmarks, validation of statistical measures, and integration testing to ensure the new models function correctly within the existing application environment. For example, a traffic management system might download updated vehicle flow prediction models with enhanced uncertainty quantification, while a predictive maintenance platform might retrieve improved equipment failure detection models that incorporate statistical confidence measures from multiple industrial facilities.

In block 1740, the Edge Nodes run the current application with the appropriate LLM/SLM(s). This execution process involves deploying and operating the applications and machine learning models that have been retrieved and validated through the previous steps in the method. The edge nodes may initialize the applications with appropriate configuration parameters, allocate computational resources for model inference operations, and establish monitoring mechanisms to track application performance and model accuracy. The execution process may include real-time data processing, inference generation, and result delivery to connected systems or users. For example, a smart agriculture monitoring system might execute crop health analysis applications using updated plant disease detection models, while an industrial quality control system might run defect identification applications with enhanced statistical confidence measures to improve manufacturing process reliability.

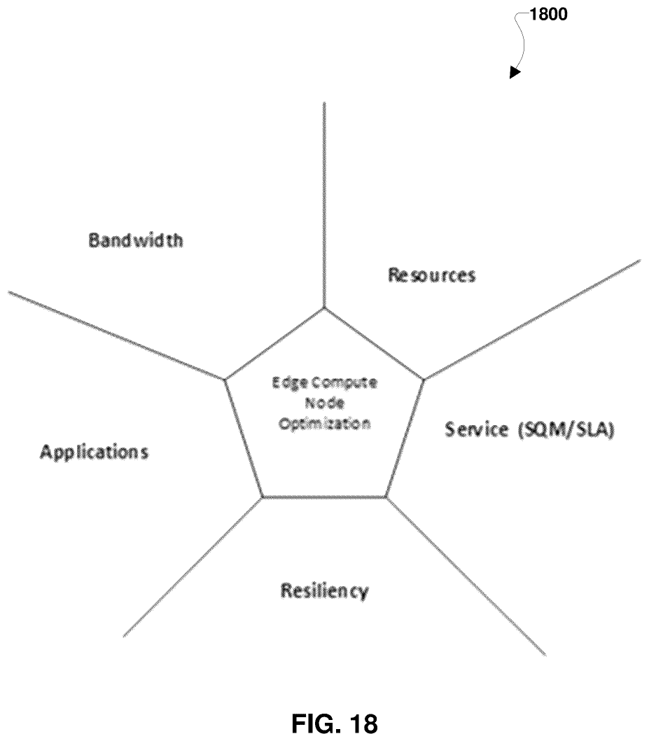

Functions of an edge compute optimization 1800 in a network design are illustrated in FIG. 18. The LLM/SLM components for network optimization in edge computing are also shown in FIG. 18.

FIG. 18 illustrates the edge compute node optimization process through five distinct subdomains, each representing a critical aspect of network and service delivery optimization. These subdomains serve as a classification framework for various inputs, enabling the Large Language Models (LLMs) or Smaller Learning Models (SLMs) to achieve optimal performance in network management and service provision. The five subdomains depicted in FIG. 18 may each be managed by a separate LLM/SLM, allowing for specialized processing and decision-making within each domain. However, the flexibility of this approach allows for the number of subdomains to be adjusted based on the specific optimization objectives and functional requirements of the network.

In the context of a Federated Learning with Blockchain and Artificial Intelligence (FLwBC-AI) system, the optimization process is further enhanced by the use of smart contracts deployed on the blockchain. These smart contracts play a crucial role in defining the optimization goals for the entire system and specifying which LLM/SLM or combination of LLM/SLMs are required to meet these objectives. This blockchain-based approach ensures that the optimization parameters and model selection criteria are transparently and immutably recorded, allowing for consistent implementation across all edge computing nodes in the network.

The smart contract's ability to define optimization goals and select appropriate models dynamically enables the FLwBC-AI system to adapt to changing network conditions and service requirements. For instance, if a particular subdomain requires more intensive processing due to increased network traffic or complex service demands, the smart contract can specify the deployment of a more sophisticated LLM. Conversely, for simpler tasks or in resource-constrained environments, it may opt for an SLM to optimize computational efficiency.

This intelligent, contract-driven model selection and optimization strategy ensures that the edge computing network can maintain optimal performance while efficiently allocating computational resources. It also facilitates a more agile and responsive network architecture, capable of evolving its optimization strategies in real-time based on predefined criteria encoded in the blockchain smart contracts.

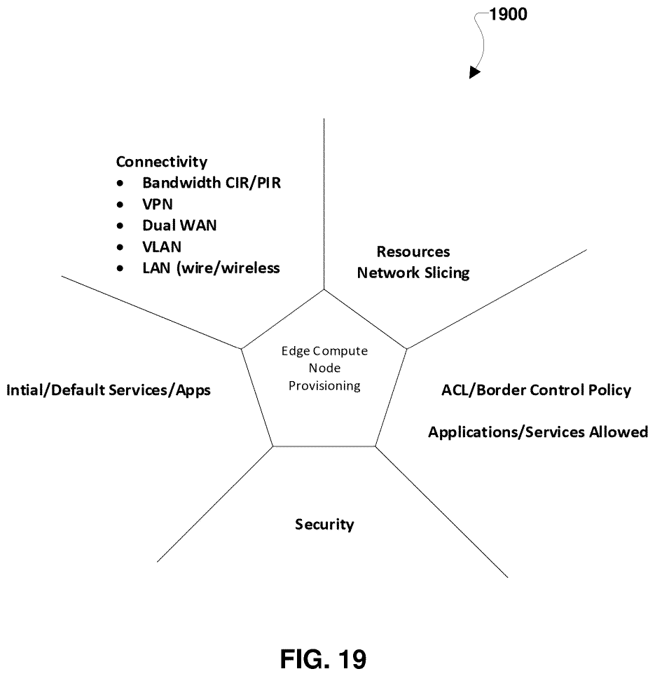

FIG. 19 illustrates the edge compute node provisioning process 1900, which is divided into five distinct subdomains. These subdomains serve as a classification framework for various inputs, enabling the Large Language Models (LLMs) or Smaller Learning Models (SLMs) to achieve optimal provisioning for network and service delivery. The five subdomains depicted in FIG. 19 may each be managed by a separate LLM/SLM, allowing for specialized processing and decision-making within each domain. However, the flexibility of this approach allows for the number of subdomains to be adjusted based on the specific optimization objectives and functional requirements of the network.

For instance, within the Connectivity subdomain shown in FIG. 19, each topic could be associated with its own LLM/SLM. These individual models might focus on specific aspects such as wireless protocols, network topology, or bandwidth allocation. The combined outputs from these specialized LLM/SLMs would then contribute to the overall optimal provisioning process for the connectivity function. This modular approach allows for fine-tuned optimization of each aspect of connectivity while maintaining a cohesive overall strategy.

This methodology extends beyond the Connectivity subdomain and can be applied to other subdomains illustrated in FIG. 19, such as Resource Allocation, Application/Service Delivery, Security, and Initial/Default Services. Each of these subdomains could be further broken down into specific topics, each potentially managed by its own LLM/SLM. For example, in the Security subdomain, separate models might handle threat detection, access control, and encryption protocols.

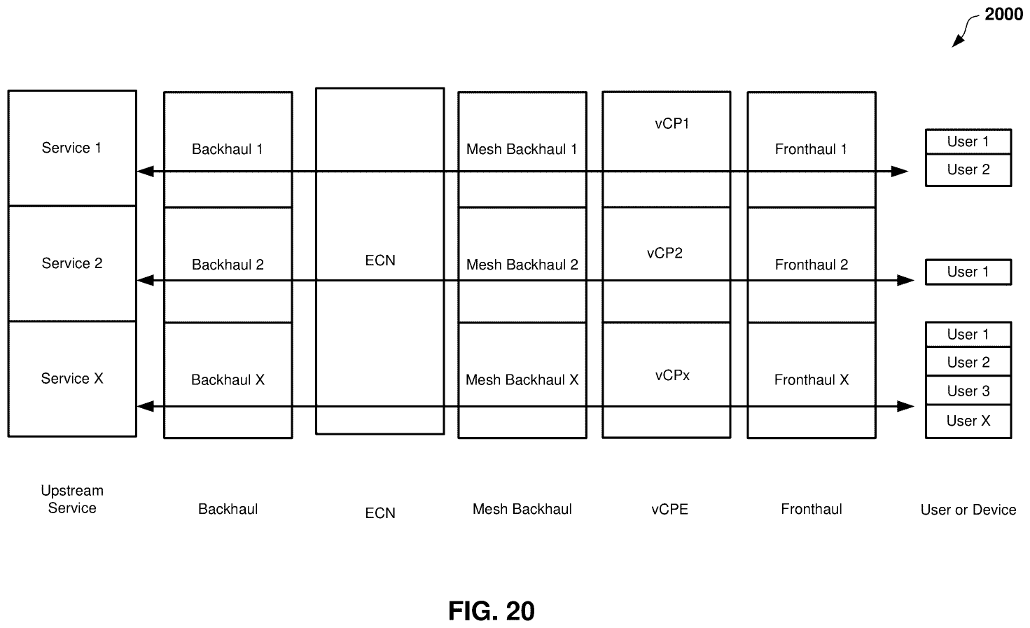

FIG. 20 illustrates various aspects of a federated learning system 2000 implementing a distributed network architecture in accordance with various embodiments. FIG. 20 shows a hierarchical system with multiple processing layers that enable data flow and communication between upstream services and end users or devices.

The federated learning system 2000 includes upstream service components positioned at the leftmost layer, which may provide initial data processing and service coordination functions similar to the fed server 110 described in FIG. 1. These upstream service components connect to backhaul elements that facilitate data transmission between different network segments, analogous to the communication pathways shown between the controller nodes and edge nodes in previous figures.

The system 2000 incorporates an Edge Computing Node (ECN) layer that serves as a central processing hub, similar in function to the edge computing nodes described throughout the various embodiments, such as edge node A 120 and edge node B 130 in FIG. 1. The ECN layer may deploy artificial intelligence and machine learning models (LLM/SLM) and perform local data processing operations as described in the federated learning framework.

Connected to the ECN layer are mesh backhaul components that provide distributed connectivity and redundancy, enabling communication between multiple network segments. These mesh backhaul elements may support the blockchain infrastructure for secure and immutable data logging as described in the various embodiments.

The system 2000 includes virtual customer premises equipment (vCPE) components that interface between the mesh backhaul and fronthaul elements. The vCPE components may run containerized environments for AI/ML components, similar to the containerized architectures described in previous figures such as the microservices implementations shown in FIG. 13.

Fronthaul components in the system 2000 provide the final connectivity layer before reaching end users or devices. These fronthaul elements may aggregate outputs from multiple LLM/SLM models and deliver processed information to applications, similar to the aggregation processes described in the various embodiments.

At the rightmost layer, the system 2000 connects to user or device endpoints that receive the processed data and services. These endpoints may represent the edge devices that provide input data to the edge computing nodes, as described in the federated learning process where data is collected locally from connected edge devices.

The parallel arrangement of components in the federated learning system 2000 supports multiple simultaneous processing paths, enabling the system to handle diverse data flows and service requirements while maintaining the distributed architecture principles described throughout the various embodiments.

The processing system employs this multi-model approach to ensure the network's readiness for scalable growth, adapting to the evolving demands of the organization it supports. A key aspect of this scalability is network slicing, where an optimal solution is achieved using an SLM. Network slicing allows for the creation of multiple virtual networks on a single physical infrastructure, each optimized for different purposes or services. This technique enables efficient resource allocation and performance optimization for diverse applications running on the same network infrastructure.

By leveraging these advanced provisioning techniques, including the use of multiple specialized LLM/SLMs and network slicing, the system can dynamically adjust to changing requirements, ensure efficient resource utilization, and maintain optimal performance as the network scales over time. This approach not only enhances the current operational efficiency but also provides a foundation for future expansion and adaptation to emerging technologies and service demands.

In the context of Federated Learning with Blockchain and Artificial Intelligence (FLwBC-AI), network slicing may include creating multiple virtual networks on a single physical infrastructure, each optimized for different purposes. This process may begin with a generalized Large Language Model (LLM) that provides a broad, initial configuration for the network, serving as a baseline model. Following this initialization, the system may use a series of Large Language Models (LLMs) or Smaller Learning Models (SLMs) to further refine the network slicing. These models may run in parallel or sequentially, depending on the specific requirements of the network.

The processing system may use various techniques to achieve optimal network slicing. One such technique ensures that the network delivers the best possible performance from one end to the other without any guaranteed service level. Another involves reaching an agreement between SLMs on the optimal configuration and resource allocation across the network. The network may also dynamically adjust its configuration and resource allocation based on the current load, optimizing performance under varying conditions. In addition, the network configuration and resource allocation may be adjusted based on the availability of resources (e.g., for efficient utilization). The system may incorporate self-healing mechanisms that enable it to recover from failures and extend its capabilities without manual intervention.

The processing system may support advanced configurations to enhance network performance and reliability. Utilizing multiple Wide Area Networks (WANs) for backhaul, the system may optimize data transfer across different network paths. Implementing a hybrid mesh network for backhaul may improve redundancy and reliability by using multiple interconnected nodes. The system may automatically group devices and nodes based on specific criteria (e.g., to enhance network organization and management, etc.).

To ensure secure and efficient network operation, the system may incorporate trust domains and policy management. Establishing trust domains using techniques such virtual Pre-Shared Keys (vPSK) and virtual Trust-Based Authentication (vTBA) may secure communications. In addition, policies may be implemented through LLMs or SLMs to manage and enforce network rules and configurations, ensuring uniformity and scalability.

Policy rules may be implemented using a series of LLMs or SLMs, replacing templates to ensure uniformity and scalability. The vPC agent may use these policy LLMs or SLMs to manage both backhaul and QoS within an edge compute network.

The processing system may include a default or initial LLM or SLM model used before localized training. This hierarchical LLM or SLM model process for edge node policy may allow customer-created weights or adjustments to override existing model weights or decisions. This customization may help meet specific requirements that the LLM or SLM process alone may not address (e.g., as determined appropriate by the local administrator, etc.).

Some embodiments may include a processing system configured to introduce artificial intelligence at the edge of the network and to provide unique capabilities for resolving configuration and application delivery in a dynamic ecosystem (elastic edge computing) with heterogeneous edge computing nodes and edge devices. These operations may include the addition and removal of edge computing nodes, changes in backhaul, upstream network resource use, resource allocation among edge computing nodes, and resource allocation for edge devices.

In some embodiments, the processing system may be configured to facilitate edge intelligence through the convergence of artificial intelligence with federated learning and blockchain, representing a new paradigm in edge computing. Some embodiments may include a federated learning component that provides a solution for building a cross-enterprise, cross-data, and cross-domain ecosystem for big data and AI systems with distributed and heterogeneous edge servers. These servers may have access to varying amounts of data and diverse computing and storage capacities. The federated learning systems may use blockchain's inherent features (e.g., immutability, security, traceability, etc.). The dynamic environment may also include node addition and removal, changes in backhaul, upstream network resource use, and resource allocation among nodes.

In some embodiments, the processing system may be configured to implement a federated learning system that may include a distributed training framework that trains machine learning models over data collected, either stored or processed in real-time, on a large number of nodes by one or multiple data owners.

In some embodiments, the processing system may be configured to reduce communication overhead in federated learning using blockchain by maintaining a select or optimized number of active parameters for node communication and training for artificial intelligence models.

In some embodiments, the processing system may be configured to use artificial intelligence with neural networks, which may use weights and biases to enable the neural network to arrive at a decision based on specific inputs. The setting and adjustment of weights and biases are important attributes of neural networks. These adjustments may occur during a training session, and during the inference process with real data. The results may be dictated by the quality of the input data and the training of the neural network.

In some embodiments, the processing system may be configured to support continuous learning, an ongoing process in which the neural network adapts to new data and problems while retaining previous correct training, ensuring an adaptive and accurate model.

In some embodiments, the processing system may be configured to use federated learning in systems with distributed and heterogeneous edge servers that have access to varying amounts of data and diverse computing and storage capacities.

In some embodiments, the processing system may be configured to perform specific operations to enhance edge computing capabilities using artificial intelligence, federated learning, and blockchain. The system may include processors configured to execute instructions for deploying microservices, managing smart contracts, provisioning edge devices, network optimization and resiliency, continuous learning, and integrating federated learning with blockchain.

In some embodiments, the processing system may be configured to deploy multiple microservices, each containing a large language model or a smaller learning model. These microservices may run in parallel to produce outputs that are then used as inputs to a general or aggregation large language model or smaller learning model.

In some embodiments, the processing system may be configured to manage smart contracts to instruct the edge computing node on which service or application to run. Smart contracts may also inform the edge computing node about which large language model or smaller learning model to use for each microservice, the location of the models and their updated weights on the blockchain or an alternative data location such as the Inter Planetary File System (IPFS), and where to store the updated models and weights.

In some embodiments, the processing system may be configured to provision edge computing nodes using smart contracts so that the nodes have the necessary resources and configurations to perform their tasks efficiently.

In some embodiments, the processing system may be configured to use large language models or smaller learning models to achieve network optimization and resiliency by dynamically adjusting network configurations based on real-time data and performance metrics.

In some embodiments, the processing system may be configured to support continuous learning by updating the weights and biases of neural networks based on new data and problems encountered, without discarding previous training, thereby maintaining an adaptive and accurate model.

In some embodiments, the processing system may be configured to integrate federated learning with blockchain technology to facilitate secure and decentralized training of machine learning models. This combination may reduce communication overhead and maintain data privacy by keeping data local while aggregating model updates on the blockchain for immutability and traceability.

In some embodiments, the processing system may be configured to implement and use federated learning with blockchain and artificial intelligence (FLwBC-AI) to allow large-scale data sets to be used for training models while keeping the data private at the edge or on a wide-area private network. Some federated learning systems have raised concerns regarding privacy protection, communication costs, system heterogeneity, and unreliable model uploads in actual operation. Integrating with blockchain provides an opportunity to improve privacy, security, and performance in addition to increasing the scope and enhancing the operations and capabilities of edge applications running on an edge computing node.

In some embodiments, the processing system may be configured to allow for the use of properly trained models for successful AI use case implementation. Training models using federated learning may have many benefits, leveraging contained devices, whether edge computing nodes or edge devices, for training models. The edge computing nodes may perform local training, which may then be used to improve the global model that is subsequently incorporated into the blockchain.

In some embodiments, the processing system may be configured to combine artificial intelligence and machine learning with blockchain and federated learning technologies to achieve more decentralization and privacy.

In some embodiments, the processing system may be configured to eliminate the need for a centralized server that collects data and performs model training, one of the many attributes of federated learning with blockchain and artificial intelligence.

In some embodiments, the processing system may be configured to improve edge network performance and application delivery by using federated learning with blockchain and artificial intelligence.

In some embodiments, the processing system may be configured to determine the optimal setting of edge intelligence based on multiple criteria, which include device capability, latency, privacy, energy efficiency, resource cost, and bandwidth cost, considering that these settings are application-dependent.

In some embodiments, the processing system may be configured to use artificial intelligence to develop computer systems and algorithms that may perform tasks that typically require human intelligence.

In some embodiments, the processing system may be configured to use Generative artificial intelligence (GenAI), a subset of artificial intelligence focused on creating content in a creative and human-like manner, such as generating text, images, videos, and other multimedia elements.

In some embodiments, the processing system may be configured to use Language Models (LLMs), a specific subset of Generative artificial intelligence models. LLMs are pre-trained on massive datasets, allowing them to understand and produce coherent and contextually appropriate outputs.

In some embodiments, the processing system may be configured to process data near the data source, a concept known as edge computing. Edge computing, in contrast to conventional centralized cloud computing, uses decentralized computing resources to improve real-time processing and lower latency.

In some embodiments, the processing system may be configured to use federated learning, a machine learning technique focused on decentralized model training across multiple devices or edge servers. federated learning transmits and aggregates only model updates—not raw data—from each device, in which the model is trained locally. Clients train their models with their own data, and after completion, the models are uploaded to a central server in which all client models are aggregated, converging to a single final model created from the uploaded models.

In some embodiments, the processing system may be configured to differentiate between edge computing and federated learning, noting that both involve distributed computing but have different attributes. Specifically, edge computing focuses on local data processing to reduce latency and facilitate real-time applications, while federated learning focuses on decentralized model training and sending model updates while maintaining local data.

In some embodiments, the processing system may be configured to perform on-device learning, which has several advantages over centralized training. Devices independently performing on-device learning retain information about local data samples, maintaining user privacy. On-device learning also eliminates or significantly reduces the communication payload required to upload collected training samples to a centralized server.

In some embodiments, the processing system may be configured to address the growing importance of on-device learning with the proliferation of Internet of Things (IoT) devices and other end devices that produce massive amounts of data. On-device learning reduces the demand for upstream devices or servers to process data in a centralized manner.

In some embodiments, the processing system may be configured to handle the heterogeneity of edge devices and edge computing nodes, which present additional complications for processing data and training models. Devices may have different communication capabilities and experience different data distributions and quantities of data samples available.

In some embodiments, the processing system may be configured to build real-world applications powered by federated learning despite the challenges posed by heterogeneity in these environments. Some edge devices or edge computing nodes may be unable to perform training and may rely on externally trained models.

In some embodiments, the processing system may be configured to manage the different attributes of heterogeneity that may help or hinder training. This may include different hardware or software generations of devices or device tiers cooperating in one federated learning system, degradation of components affecting available resources, unstable power or energy supply, ambient temperature affecting cooling or heating, and shared resource contention with other applications running on a device.

In some embodiments, the processing system may be configured to overcome the complications arising from the heterogeneity of edge devices and edge computing nodes. One method may include deploying only devices with the same capability in the ecosystem. Another method may include using smaller, purpose-driven models referred to as Smaller Learning Models (SLMs), which may be smaller or pruned versions of Large Language Models (LLMs) designed to run on contained devices in which some or most of the generality of the LLM is not needed for the specific application.

In some embodiments, the processing system may be configured to follow a server-client model in which devices (client workers) do the training and then communicate with a central server to share the training knowledge. federated learning components may be configured to increase convergence speed and reach high final accuracy despite having constrained devices.

Some embodiments may be implemented on a variety of commercially available computing devices, such as the server computing device XX00 illustrated in FIG. XX. The server device XX00 may include one or more processors XX01 (e.g., multi-core processor, etc.) coupled to volatile memory XX02, such as RAM, and a large capacity nonvolatile memory, such as a solid-state drive (SSD) XX03. The server device XX00 may also include additional storage interfaces such as USB ports and NVMe slots coupled to the processor XX01. The server device XX00 may include network access ports XX06 coupled to the processor XX01 that allow data connections through a network interface card (NIC) XX04 and a communication network XX07 (e.g., an Internet Protocol (IP) network) connected to other network elements.

The edge computing system may be made up of multiple edge computing systems all connected in a mesh environment. The edge computing devices may be a heterogeneous hardware environment in which different edge computing devices have different capabilities depending on their internal architectures which may include CPU type, RAM, storage capabilities, wireless and wired capabilities as well as kernel capabilities and version. The heterogeneous environment may also include edge devices that have the same identical platforms but operating with different software versions.

The processors or processing units discussed in this application may be any programmable microprocessor, microcomputer, or multiple processor chip or chips that may be configured by software instructions (applications) to perform a variety of functions, including the functions of various embodiments described. In some computing devices, multiple processors may be provided, such as one processor within first circuitry dedicated to wireless communication functions and one processor within a second circuitry dedicated to running other applications. Software applications may be stored in the memory before they are accessed and loaded into the processor. The processors may include internal memory sufficient to store the application software instructions.

Implementation examples are described in the paragraphs above and below in terms of example methods. Further example implementations may include: the example methods discussed in the above and below paragraphs implemented by a computing device including a processor configured (e.g., with processor-executable instructions) to perform operations of the methods of the above and below implementation examples; the example methods discussed in the above and below paragraphs implemented by a computing device including means for performing functions of the methods of the above and below implementation examples; and the example methods discussed in the above and below paragraphs may be implemented as a non-transitory processor-readable storage medium having stored thereon processor-executable instructions configured to cause a processor of a computing device to perform the operations of the methods of the following implementation examples.

In various embodiments, a method comprises obtaining new data at an edge node, checking a federated server for a new or updated large language model (LLM) or smaller learning model (SLM), obtaining the new or updated LLM/SLM if available or otherwise utilizing a current LLM/SLM, training the LLM/SLM using the new data set, and sending an updated LLM/SLM to the federated server upon completion of training.

In some embodiments, the method may further include receiving the updated LLM/SLM at the federated server from multiple edge nodes, aggregating the received model updates to create an improved global model, and making the improved global model available for distribution to edge nodes. In some aspects, aggregating the received model updates may involve applying a federated averaging algorithm to combine model parameters from multiple edge nodes. In some cases, training the LLM/SLM may include computing covariance matrix values for each layer of the neural network model and storing the covariance matrix values along with the updated model parameters. In some embodiments, sending the updated LLM/SLM to the federated server may involve transmitting the computed covariance matrix values along with the updated model parameters to enable statistical aggregation of confidence measures across multiple edge nodes.

In various embodiments, a method comprises obtaining local data at an edge node, determining a required LLM/SLM for a function or application, obtaining the required LLM/SLM from a local source, other edge nodes, or a federated server, training the LLM/SLM using a public data set if available, training the LLM/SLM using the local data set, sending an updated LLM/SLM to a federated server or local edge nodes, obtaining new local data, checking the federated server for a new or updated LLM/SLM, obtaining the new or updated LLM/SLM if available or otherwise utilizing a current LLM/SLM, training the LLM/SLM using the new local data set, and sending the updated LLM/SLM to the federated server or local edge nodes.

In some embodiments, obtaining the required LLM/SLM may involve querying neighboring edge nodes for model sharing opportunities before contacting the federated server. In some aspects, training the LLM/SLM using the local data set may include computing covariance matrix values for each layer of the neural network model and storing the covariance matrix values along with updated model parameters. In some cases, sending the updated LLM/SLM to the federated server or local edge nodes may involve transmitting the computed covariance matrix values along with the updated model parameters to enable statistical aggregation of confidence measures. In some embodiments, the method may further include receiving an aggregated global model from the federated server, where the aggregated global model incorporates statistical confidence information from multiple edge nodes.

In various embodiments, a method comprises selecting an LLM/SLM matching an AI function, obtaining a data set containing values, obtaining confidence values for the data set, obtaining covariance matrix confidence values, assigning weights using a Kalman Filter Algorithm incorporating current and previous confidence values, applying weights to data set values based on confidence values, summing the weighted data set values, and updating covariance matrix confidence values if the summation does not match a desired output.

In some embodiments, selecting the LLM/SLM matching the AI function may involve evaluating multiple available models based on their capabilities, computational requirements, and suitability for the intended use case. In some aspects, obtaining the covariance matrix confidence values may include calculating statistical relationships and confidence levels between different variables in the data set based on historical data analysis. In some cases, assigning weights using the Kalman Filter Algorithm may involve dynamically adjusting the importance of different data elements based on their confidence levels and historical accuracy patterns. In some embodiments, the method may further include iteratively refining the weights and covariance matrix confidence values through multiple training cycles to improve model accuracy and convergence speed.

In various embodiments, a method comprises obtaining data for training an LLM/SLM at an edge node, commencing training using a neural network training container, completing training using a local data set, storing a newly trained LLM/SLM, querying edge nodes for LLM/SLM updates at a control node, sending new LLM/SLM from edge nodes to the control node, commencing training of the LLM/SLM at the control node, completing training using edge node training data, updating the LLM/SLM model at the control node, and updating the LLM/SLM at the edge nodes.

In some embodiments, storing the newly trained LLM/SLM may involve computing covariance matrix values for each layer of the neural network model and storing the covariance matrix values along with updated model parameters. In some aspects, sending new LLM/SLM from edge nodes to the control node may include transmitting the computed covariance matrix values along with the updated model parameters to enable statistical aggregation of confidence measures. In some cases, completing training using edge node training data at the control node may involve aggregating the covariance matrix values from multiple edge nodes to create a global model with enhanced statistical confidence measures for each layer. In some embodiments, updating the LLM/SLM at the edge nodes may include retrieving the updated global model with its associated covariance matrix values from the control node and deploying the updated global model locally while maintaining statistical confidence information for each layer.

In various embodiments, a method comprises obtaining data for training an LLM/SLM at an edge node, commencing training using a neural network training container, completing training using a local data set, storing a newly trained LLM/SLM including covariance matrix values for each layer, querying edge nodes for LLM/SLM covariance matrix value updates at a control node, sending new LLM/SLM covariance matrix values from edge nodes to the control node, commencing training of the LLM/SLM at the control node, completing training using edge node training data, updating the LLM/SLM model including covariance matrix values at the control node, and updating the LLM/SLM at the edge nodes.

In some embodiments, storing the newly trained LLM/SLM including covariance matrix values for each layer may involve generating metadata that documents confidence measures and statistical relationships captured in each layer's covariance matrix and implementing versioning capabilities to track different iterations of the model and its associated covariance matrices. In some aspects, sending new LLM/SLM covariance matrix values from edge nodes to the control node may include encrypting the covariance matrix data to protect confidence information during transmission and including statistical metadata such as confidence intervals, correlation coefficients, and sample sizes along with the covariance matrix values. In some cases, completing training using edge node training data at the control node may involve aggregating the covariance matrix values from multiple edge nodes to create a global model with enhanced statistical confidence measures for each layer and optimizing the global model's performance while preserving confidence measures and uncertainty quantification. In some embodiments, updating the LLM/SLM at the edge nodes may include retrieving the updated global model with its associated covariance matrix values from the control node, verifying the statistical integrity of the received model and covariance matrices, and gradually deploying the updated model to ensure smooth transition without disrupting ongoing operations.

In various embodiments, a method comprises obtaining data for training an LLM/SLM at an edge node, commencing training using a neural network training container, completing training using a local data set, storing a newly trained LLM/SLM including covariance matrix values for each layer, querying edge nodes for LLM/SLM covariance matrix value updates at a control node, sending new LLM/SLM covariance matrix values from edge nodes to the control node, commencing training of the LLM/SLM at the control node, completing training using edge node training data, updating the LLM/SLM model with covariance matrix values and storing it on a blockchain or IPFS, updating a smart contract indicating the location of the updated LLM/SLM model, querying the smart contract by edge nodes to determine availability of a new LLM/SLM, obtaining the location of the new LLM/SLM from the smart contract, and obtaining the new LLM/SLM from the blockchain or IPFS.

In some embodiments, storing the newly trained LLM/SLM including covariance matrix values for each layer may involve generating metadata that documents confidence measures and statistical relationships captured in each layer's covariance matrix and implementing versioning capabilities to track different iterations of the model and its associated covariance matrices. In some aspects, sending new LLM/SLM covariance matrix values from edge nodes to the control node may include encrypting the covariance matrix data to protect confidence information during transmission and including statistical metadata such as confidence intervals, correlation coefficients, and sample sizes along with the covariance matrix values. In some cases, completing training using edge node training data at the control node may involve aggregating the covariance matrix values from multiple edge nodes to create a global model with enhanced statistical confidence measures for each layer and optimizing the global model's performance while preserving confidence measures and uncertainty quantification. In some embodiments, updating the LLM/SLM at the edge nodes may include retrieving the updated global model with its associated covariance matrix values from the blockchain or IPFS, verifying the statistical integrity of the received model and covariance matrices using cryptographic hashes stored in the smart contract, and gradually deploying the updated model to ensure smooth transition without disrupting ongoing operations.

In various embodiments, a method comprises querying a smart contract on a blockchain by edge nodes to obtain instructions, reading the smart contract to determine availability of new application code or a new LLM/SLM, obtaining location information for applications or sub-programs from the smart contract, obtaining applications or updates from the blockchain, obtaining location information for new LLM/SLM models from the smart contract, obtaining new LLM/SLM models from the blockchain or IPFS, and running a current application with current LLM/SLM models.

In some embodiments, querying the smart contract may involve periodically checking the blockchain for updates to the smart contract and evaluating model version numbers against locally stored versions to determine if updates are available. In some aspects, reading the smart contract may include parsing smart contract data to extract blockchain block numbers containing model components and IPFS hash addresses for large model files. In some cases, obtaining new LLM/SLM models may involve downloading model parameters and weights from the specified blockchain or IPFS locations, verifying model integrity through cryptographic hash checking, and validating model compatibility with local hardware and software environments. In some embodiments, the method may further include gradually deploying the new LLM/SLM models while monitoring their performance against historical baselines and implementing rollback mechanisms to restore previous model versions if performance issues are detected.

A number of different types of memories and memory technologies are available or contemplated in the future, any or all of which may be included and used in systems and computing devices that implement the various embodiments. Such memory technologies/types may include non-volatile random-access memories (NVRAM) such as Magnetoresistive RAM (M-RAM), resistive random access memory (ReRAM or RRAM), phase-change random-access memory (PC-RAM, PRAM or PCM), ferroelectric RAM (F-RAM), spin-transfer torque magnetoresistive random-access memory (STT-MRAM), and three-dimensional cross point (3D-XPOINT) memory. Such memory technologies/types may also include non-volatile or read-only memory (ROM) technologies, such as programmable read-only memory (PROM), field programmable read-only memory (FPROM), one-time programmable non-volatile memory (OTP NVM). Such memory technologies/types may further include volatile random-access memory (RAM) technologies, such as dynamic random-access memory (DRAM), double data rate (DDR) synchronous dynamic random-access memory (DDR SDRAM), static random-access memory (SRAM), and pseudostatic random-access memory (PSRAM). Systems and computing devices that implement the various embodiments may also include or use electronic (solid-state) non-volatile computer storage mediums, such as FLASH memory. Each of the above-mentioned memory technologies include, for example, elements suitable for storing instructions, programs, control signals, and/or data for use in a computing device, system on chip (SOC) or other electronic component. Any references to terminology and/or technical details related to an individual type of memory, interface, standard or memory technology are for illustrative purposes only, and not intended to limit the scope of the claims to a particular memory system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include random access memory (RAM), read-only memory (ROM), electrically erasable programmable read-only memory (EEPROM), FLASH memory, solid-state drives (SSD), non-volatile memory express (NVMe) drives, three-dimensional (3D) NAND flash, or any other medium that may be used to store target program code in the form of instructions or data structures and that may be accessed by a computer. Modern technologies, such as cloud-based storage solutions, including infrastructure-as-a-service (IaaS) platforms, may offer scalable and distributed options for storing and accessing program code. Additionally, the operations of a method or algorithm may reside as one or any combination or set of codes and/or instructions on a non-transitory processor-readable medium and/or computer-readable medium, which may be incorporated into a computer program product. Emerging technologies, including quantum computing storage media and blockchain-based storage solutions, may further enhance data integrity and security. artificial intelligence (AI) and machine learning (ML)-optimized hardware accelerators, such as graphical processing units (GPUs) and tensor processing units (TPUs), may be used to execute complex algorithms.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method for enabling distributed machine learning across edge computing nodes, the method comprising:
obtaining new data at an edge node;
checking a federated server for a new or updated large language model (LLM) or smaller learning model (SLM);
obtaining the new or updated LLM/SLM if available, otherwise utilizing a current LLM/SLM;
training the LLM/SLM using the new data set; and
sending an updated LLM/SLM to the federated server upon completion of training.

2. The method of claim 1, further comprising:
receiving the updated LLM/SLM at the federated server from multiple edge nodes;
aggregating the received model updates to create an improved global model; and
making the improved global model available for distribution to edge nodes.

3. The method of claim 2, wherein aggregating the received model updates comprises:
applying a federated averaging algorithm to combine model parameters from multiple edge nodes.

4. The method of claim 1, wherein training the LLM/SLM comprises:
computing covariance matrix values for each layer of the neural network model; and
storing the covariance matrix values along with the updated model parameters.

5. The method of claim 4, wherein sending the updated LLM/SLM to the federated server comprises:
transmitting the computed covariance matrix values along with the updated model parameters to enable statistical aggregation of confidence measures across multiple edge nodes.

6. An edge computing apparatus for enabling distributed machine learning, the apparatus comprising:
a processor;
a memory coupled to the processor; and
a network interface configured to communicate with a federated server, wherein the processor is configured with processor-executable instructions to:
check the federated server for a new or updated large language model (LLM) or smaller learning model (SLM);
obtain the new or updated LLM/SLM if available, otherwise utilize a current LLM/SLM;
train the LLM/SLM using the new data set; and
send an updated LLM/SLM to the federated server upon completion of training.

7. The edge computing apparatus of claim 6, wherein the processor is further configured with processor-executable instructions to:
receiving the updated LLM/SLM at the federated server from multiple edge nodes;
aggregating the received model updates to create an improved global model; and
making the improved global model available for distribution to edge nodes.

8. The edge computing apparatus of claim 7, wherein the processor is further configured with processor-executable instructions such that aggregating the received model updates comprises:
applying a federated averaging algorithm to combine model parameters from multiple edge nodes.

9. The edge computing apparatus of claim 6, wherein the processor is further configured with processor-executable instructions such that training the LLM/SLM comprises:
computing covariance matrix values for each layer of the neural network model; and
storing the covariance matrix values along with the updated model parameters.

10. The edge computing apparatus of claim 9, wherein the processor is further configured with processor-executable instructions such that sending the updated LLM/SLM to the federated server comprises:
transmitting the computed covariance matrix values along with the updated model parameters to enable statistical aggregation of confidence measures across multiple edge nodes.

11. A method for sequential execution of multiple tasks on an edge computing node, comprising:
receiving, from a smart contract, a first pointer that locates a first covariance matrix;
loading the first covariance matrix into a neural network stored on the edge computing node;
processing sensor data with the neural network to obtain a first task output;
receiving, from the smart contract, a second pointer that locates a second covariance matrix;
loading the second covariance matrix into the neural network;
processing the sensor data with the neural network to obtain a second task output;
optionally receiving, from the smart contract, a third pointer that locates a third covariance matrix;
loading the third covariance matrix into the neural network; and
processing the first task output and the second task output with the neural network to obtain a combined output.

12. The method of claim 11, wherein each pointer resides in a field named matrix_pointer within the smart contract.

13. The method of claim 11, wherein the smart contract resides on a blockchain that uses an interplanetary file system for matrix storage.

14. The method of claim 11, wherein the logic measures available memory and decides whether to load the third covariance matrix.

15. The method of claim 11, further comprising:
monitoring performance metrics of the neural network during task execution;
generating updated covariance matrix values based on the performance metrics;
storing the updated covariance matrix values on the blockchain or IPFS; and
updating the smart contract with new pointers to the updated covariance matrix values.

16. An edge computing node apparatus for sequential execution of multiple tasks, comprising:
a processor;
a memory coupled to the processor;
a neural network stored in the memory; and
a communication interface configured to receive pointers from a smart contract, wherein the processor is configured with processor-executable instructions to:
receive, via the communication interface from the smart contract, a first pointer that locates a first covariance matrix;
load the first covariance matrix into the neural network;
process sensor data with the neural network to obtain a first task output;
receive, via the communication interface from the smart contract, a second pointer that locates a second covariance matrix;
load the second covariance matrix into the neural network;
process the sensor data with the neural network to obtain a second task output;
optionally receive, via the communication interface from the smart contract, a third pointer that locates a third covariance matrix;
load the third covariance matrix into the neural network; and
process the first task output and the second task output with the neural network to obtain a combined output.

17. The edge computing node apparatus of claim 16, wherein the processor is further configured with processor-executable instructions such that each pointer resides in a field named matrix_pointer within the smart contract.

18. The edge computing node apparatus of claim 16, wherein the processor is further configured with processor-executable instructions such that the smart contract resides on a blockchain that uses an interplanetary file system for matrix storage.

19. The edge computing node apparatus of claim 16, wherein the processor is further configured with processor-executable instructions such that the logic measures available memory and decides whether to load the third covariance matrix.

20. The edge computing node apparatus of claim 16, wherein the processor is further configured with processor-executable instructions to:
monitor performance metrics of the neural network during task execution;
generate updated covariance matrix values based on the performance metrics;
store the updated covariance matrix values on the blockchain or IPFS; and
update the smart contract with new pointers to the updated covariance matrix values.
